(19) United States
(12) Patent Application Publication
(10) Pub. No.: US 2025/0232011 A1
(43) Pub. Date: Jul. 17, 2025

(54) AUTHENTICATION SYSTEMS AND COMPUTER-IMPLEMENTED METHODS

(71) Applicant: REWIRE HOLDING LTD., London (GB)

(72) Inventors: Jose Luis Merino GONZALEZ, London (GB); Jesus Ruiz GONZALEZ, London (GB); Cristina Bernils ORTIZ, London (GB)

(21) Appl. No.: 18/881,833

(22) PCT Filed: Jul. 7, 2023
(86) PCT No.: PCT/GB2023/051801

§ 371 Date: Jan. 7, 2025

(30) Foreign Application Priority Data
Jul. 8, 2022 (GB) 2210043.2

(51) Int. Cl. G06F 21/31

(52) U.S. Cl. CPC G06F 21/31

(57) ABSTRACT

An authentication system including a first internet enabled wireless mobile device with a built-in microphone, speaker and camera and at least a second internet enabled wireless mobile device with a built-in microphone, speaker and camera, and at least one internet enabled server device. The first mobile device includes a first computer program product embodied on a first non-transitory storage medium. The second mobile device includes a second computer program product embodied on a second non-transitory storage medium. A third computer program product is embodied on a third non-transitory storage medium and facilitates communication between the server device and the first and/or second mobile devices.

### BACKGROUND OF THE INVENTION

### 1. Field of the Invention

The field of the invention relates to authentication systems and to authentication computer-implemented methods.

### 2. Technical Background

Traditional methods of 3D reconstruction in existing systems are evolving from deep scanning performed by highly skilled individuals and using high precision or high resolution camera devices, which is in contrast to the use of the common household devices acquired by end-users, such as mobile phones, smartphones, pads, PCs, laptops, and so forth.

The evolution of technology and the new generation of mainly smartphones or any such portable/wireless devices, with more and more people constantly using them, makes it more likely that the future will shift towards a virtual world, whose adoption is accelerated with investments of multinational companies towards an online world or metaverses and their involvement in the virtual world.

The continuous expansion of 5G coverage in mobile data, and any such other higher speed fixed/mobile internet networks such as fixed to wireless high speed WIFI, has created the appropriate framework for the use and development of a virtual world in the coming years, for which, the legislations and regulations will need to be updated where required, for all the exceptions and cases that have not yet been raised. Therefore, it is most likely that it is those platforms that are or will offer a virtual world that will have to have their own security measures regarding the people who enter them and what they can do in it, in particular depending on their age and ensuring that the individual is really who they say they are and that it is truly a live person, for example and not a “bot” or a person that is not responsive for example when a remote pilot is flying a drone or remotely driving a truck/car/bus/boat which could cause potentially a critical life or death situation.

The loss of control of the virtual world in terms of security comes in part from the ignorance of the person managing the end user's device in a virtual world or the loss of concentration or falling asleep in critical use-cases. The use-cases or area of actions that can be performed virtually are so many that it is almost indefinable with the passage of time.

For this reason, the state of the art has adapted accordingly, unifying two areas, clearly differentiated so far, such as obtaining 3D information for possible digital recreation, and obtaining security information with which the various facial recognition and life detection tests are carried out, among others.

Both areas are now part of the same path, since the technologies that are being developed in relation to the security and access of the virtual world are so advanced that they are reaching the position of the technology used for 3D scanning, so that the same methods are beginning to be used for various purposes as if it would be a one size fits all, which is clearly a shortcoming when considering previous mentioned potential critical life or death situations (e.g. remote drivers/pilots, etc.) or potential loss of all monetary savings when an account is accessed by a different person than the account holder, which examples of our invention overcome.

The issue with more weight in this story is to know the identity of the person who handles the device and the state of the art has been adapted accordingly and numerous tools have been created to mitigate only part of these shortcomings. The most advanced methods for fighting the unknown are based on the use of both the device's infrared light emitter and its infrared camera which as stated previously is far from an optimal solution and is this is a big shortcoming for critical use-cases as described earlier herein. The process of the prior art is as follows: a map of light points is emitted from the mobile device, which will be projected on the face of the person who is in front of the frontal focus of the device, at which time a capture is made with the infrared camera; this “2D infrared image” happens to be the one processed for facial recognition in most smartphones. Even with a great processing power of smartphones, often, remote artificial intelligence (AI) systems are used thanks to which the images captured by the camera are processed on remote servers, where the processing power is greater than in the end-user smartphone or other device, or locally in the device itself, focusing resources on facial recognition.

This solution is the most efficient alternative by the state of the art, improving the results considerably in a short time in recent years thanks to the high number of resources used for it. However, as fraud cases increase and remote access or remote-control applications/use-cases take up increases at a fast pace and the need for more and more processing capacity is required accordingly, the prior art is starting to not be enough for some current and most future use-cases. This is in addition to the fact that most state of the art companies cannot count on this method of security, and, therefore, continue to use the already traditional technique of performing facial recognition with the common camera of the device, losing the ability to check the liveliness of said person with the prior art methods, or are forced to perform this screening test using other techniques such as making a video of the user and asking for voice recording and compensating by asking for a code by text or email, on-screen instructions to the user to move the head up, down or left/right or even repeat or read a text as voice recognition, all of which are not reliable nor secure enough for many current and most future use-cases as described herein in relation to examples of this invention.

The big shortcoming with previous mentioned prior arts is that such methods and systems require the end-user device and/or remote servers to have a very high processing capacity and a very high amount of storage space for all that information, thus being able to run voice or image recognition systems, in addition to requiring a high-quality camera and very good lighting conditions to achieve minimally acceptable or reliable results.

Consequently, we enter the debate, while companies with sufficient funds can afford to pay specialized third parties, it becomes a question of how many cases still escape the cases of fraudulent use or the cases of life or death or critical liveness controls of all these state-of-the-art methods, since obtaining completely reliable information is virtually impossible with the prior art, thus improvements or solutions to the shortcomings are addressed with the systems and methods of examples of this invention, within the scope of examples of this invention.

Leaving behind the field of security/safety, as we have mentioned above, almost the same methods are used in the prior art to obtain information in 3D for the purpose of a subsequent virtual representation, however, the methods developed so far that have an acceptable result are those unattainable for most of the actors with no access to less affordable equipment, which contrasts with most users when using the state of the art described here. Therefore, although they can be put in the same area of development, they have a particular shortcoming, to which, in examples of this invention, alternatives are also described in the different examples of the present invention.

Consequently, despite the improvements in the state of the art in the methods developed of recent years and the wide variety of companies that provide new and diverse techniques for the realization of obtaining this type of information, there are still shortcomings that must be overcome.

Some of the shortcomings of the prior art are as follows:
(i) A shortcoming of the state of the art is that the obtaining of the data is done in 2 dimensions.
(ii) One of the shortcomings of using the camera as the only point of entry of information is that, if the device does not have sufficient quality/resolution or the lighting conditions of the environment significantly disfavour the result of this development, there is no alternative method that can cover these problematic frequent cases, limiting the number of users who can use such development, or worse, get bad results in a massive way.
(iii) Another shortcoming in the state of the art when performing a life detection, however, as the method is developed, is that the result can only be obtained after performing a facial recognition process on several images, since it does not collect information about the depth or volume of the object or person processed, in addition to not having a “fast track” for this type of case.
(iv) As for the particular field of obtaining information with the aim of a subsequent digital representation, the methods are not practical when it comes to the storage and collection of data, since they do not directly relate the information obtained to be allowed to reproduce a minimally accurate representation, forcing to obtain said more accurate data by another way, adding a more tedious subsequent processing cycle requirement and that makes the total development more expensive due to higher storage needs or slower due to more processing need.
(v) Yet, another shortcoming of this same field is that it suffers a great limitation in terms of data capture, since the necessary distance between the device and the object/shape/animal/person which you want to obtain the information from must be close, since it depends on the infrared light emission capacity of the device, in addition to the subsequent capture, to achieve acceptable reliable results.
(vi) Another very important shortcoming is the fact that the prior art false positives detected when using their 2D extracted data with and without infrared cameras to calculate the 3D data representation is less reliable for certain groups of people giving a big difference in reliability, when using the prior art for people of African descent, Asian descent, Caribbean descent, Hispanic descent etc. or a mix of descents and so forth. Examples of this invention improve the reliability in these use-cases by the methods and systems of examples of this invention.
(vii) Yet another shortcoming of the prior art detection methods of user being alive or not (for example a photo in front of a camera) often affect the user journey such that it loses unacceptable amounts of good users as well due to the invasive effects of some of the solutions out there, like for example requesting the user to perform certain actions or screen moving the face left right or up and down and in some cases to repeat a certain text or use video, or in other prior art cases that are less invasive, the false positives are unacceptable when using images to detect movement of the person.

Although the traditional methods mentioned so far are perfectly viable as a business, since they were profitable businesses in their own right, the fact is that there are still many shortcomings that need to be overcome.

In some cases, third party companies that make this type of systems for the collection of information in 3 dimensions, let the companies or businesses that hire/contract them in order to create virtual spaces, deal only with some of the security and fraud issue that comes with their use-cases. However, the previous does not apply to a many current and most future uses-cases when considering the representation of the data collected, nor does it cover the aspects of most current or future uses-cases of anti-fraud and semi- or real-time liveness detection.

Examples of our invention solve the shortcomings of the state of the prior art mentioned herein. Examples of our invention solve the shortcomings of the prior art.

Therefore, with the prior art described herein, (e.g. all) prior art shortcomings listed in this document are overcome with the examples of the present invention.

### 3. DISCUSSION OF RELATED ART

EP2317457 (A2) and EP2317457 (B1) disclose a user authentication means for authentication of a user, which is mainly used for user authentication in Internet banking or the like and is high in security, and is realizable by functions ordinarily provided in a personal computer (PC), a mobile phone, or the like, the authenticating means being less in burden required for user authentication key management and authentication operations. Sound or an image is adopted as an authentication key for user authentication. Authentication data is edited by combining an authentication key, which is selected by a registered user, and sound or an image that is other than the authentication key, and the authentication data is continuously reproduced in a user terminal. A time in which a user has discriminated the authentication key from the reproduced audio or video is compared with a time in which the authentication key should normally be discriminated, which is specified from the authentication data. When both times agree, the user is authenticated as a registered user.

### SUMMARY OF THE INVENTION

According to a first aspect of the invention, there is provided a system including a first internet enabled wireless mobile device with a built-in microphone, speaker and camera and at least a second internet enabled wireless mobile device with a built-in microphone, speaker and camera, and at least one internet enabled server device, wherein; the first internet enabled wireless mobile device includes a first non-transitory storage medium, and a first computer program product embodied on the first non-transitory storage medium, the first computer program product executable on the first internet enabled wireless mobile device, such that the first internet enabled wireless mobile device communicates with the server, and

the second internet enabled wireless mobile device includes a second non-transitory storage medium, and a second computer program product embodied on the second non-transitory storage medium, the second computer program product executable on the second internet enabled wireless mobile device, such that the second internet enabled wireless mobile device communicates with the server, and

the internet enabled server device, including a third non-transitory storage medium, and a third computer program product embodied on the third non-transitory storage medium, wherein the third computer program product is executable on the internet enabled server device, such that the internet enabled server device communicates with at least the first internet enabled wireless mobile device and/or the second internet enabled wireless mobile device, and

wherein the first computer program product is executable on the first internet enabled wireless mobile device to operate a first data communication with the server, and wherein the second computer program product is executable on the second internet enabled wireless mobile device to operate a second data communication with the server and,

wherein the first computer program product is executable on the first internet enabled wireless mobile device to use the speaker to emit a frequency in the audible and/or inaudible human ear spectrum and to receive using the microphone the audio waves bounced back from the face, head or object in near proximity of the first mobile device and to convert the received analogue signal into a first digital signal and to transmit the first digital signal as the first data through the first data communication channel to the internet enabled server device, the internet enabled server device configured to execute the third computer program product to store the first data on a server non-transitory storage medium, and

wherein the second computer program product is executable on the second internet enabled wireless mobile device to use the speaker to emit a frequency in the audible and/or inaudible human ear spectrum and to receive using the microphone the audio waves bounced back from the face, head or object in near proximity of the second mobile device and to convert the received analogue signal into a second digital signal and to transmit the second digital signal as the second data through the second data communication channel to the internet enabled server device, the internet enabled server device executing the third computer program product to store the second data on the server non-transitory storage medium, and

wherein in the event the third computer program product executing on the internet enabled server device detects data received from the first internet enabled wireless mobile device or from the second internet enabled wireless mobile device, the data received is stored in the server non-transitory storage medium and is indexed such that each data is associated to a respective originating user account of the first internet enabled wireless mobile device user or the second internet enabled wireless mobile device user, for further processing.

An advantage is improved security through the use of emitted, measured and stored audio data.

According to a second aspect of the invention, there is provided a system including a first internet enabled wireless mobile device with a built-in microphone, speaker and camera and at least a second internet enabled wireless mobile device with a built-in microphone, speaker and camera, and at least one internet enabled server device, wherein;

the first internet enabled wireless mobile device includes a first non-transitory storage medium, and a first computer program product embodied on the first non-transitory storage medium, the first computer program product executable on the first internet enabled wireless mobile device, such that the first internet enabled wireless mobile device communicates with the server, and the second internet enabled wireless mobile device includes a second non-transitory storage medium, and a second computer program product embodied on the second non-transitory storage medium, the second computer program product executable on the second internet enabled wireless mobile device, such that the second internet enabled wireless mobile device communicates with the server;

the internet enabled server device including a third non-transitory storage medium, and a third computer program product embodied on the third non-transitory storage medium, wherein the third computer program product is executable on the internet enabled server device, such that the internet enabled server device communicates with at least the first internet enabled wireless mobile device and/or the second internet enabled wireless mobile device, and

wherein the first computer program product is executable on the first internet enabled wireless mobile device to operate a first data communication with the server, and wherein the second computer program product is executable on the second internet enabled wireless mobile device to operate a second data communication with the server and,

wherein the first computer program product is executable on the first internet enabled wireless mobile device to use a frequency transceiver or transducer that emits frequency patterns and to receive the frequency waves bounced back from the face, head or object in near proximity of the frequency transceiver or transducer built-in or externally interfacing with the first mobile device and to convert the analogue signal into a first digital signal and to transmit the first digital signal as first data through the first data communication channel to the internet enabled server device, the internet enabled server device executing the third computer program product to store the first data on a server non-transitory storage medium, and

wherein the second computer program product is executable on the second internet enabled wireless mobile device to use a frequency transceiver or transducer that emits frequency patterns and to receive the frequency waves bounced back from the face, head or object in near proximity of the frequency transceiver or transducer built-in or externally interfacing with the second mobile device and to convert the analogue signal into a second digital signal and to transmit the second digital signal as second data through the second data communication channel to the internet enabled server device, the internet enabled server device executing the third computer program product to store the second data on the server non-transitory storage medium, and wherein in the event the third computer program product executing on the internet enabled server device detects data received from the first internet enabled wireless mobile device or from the second internet enabled wireless mobile device, the data received is stored in the server non-transitory storage medium and is indexed such that each data is associated to a respective originating user account of the first internet enabled wireless mobile device user or the second internet enabled wireless mobile device user, for further processing.

An advantage is improved security through the use of transmitted frequency patterns, and measured and stored bounced back data.

According to a third aspect of the invention, there is provided a system including a first internet enabled wireless mobile device with a built-in microphone, speaker and camera and at least a second internet enabled wireless mobile device with a built-in microphone, speaker and camera, and at least one internet enabled server device, wherein; the first internet enabled wireless mobile device including a first non-transitory storage medium, and a first computer program product embodied on the first non-transitory storage medium, the first computer program product executable on the first internet enabled wireless mobile device such that the first internet enabled wireless mobile device communicates with the server, and

the second internet enabled wireless mobile device including a second non-transitory storage medium, and a second computer program product embodied on the second non-transitory storage medium, the second computer program product executable on the second internet enabled wireless mobile device such that the second internet enabled wireless mobile device communicates with the server,

the internet enabled server device including a third non-transitory storage medium, and a third computer program product embodied on the third non-transitory storage medium, wherein the third computer program product is executable on the internet enabled server device, such that the internet enabled server device communicates with at least the first internet enabled wireless mobile device and/or the second internet enabled wireless mobile device, and

wherein the first computer program product is executable on the first internet enabled wireless mobile device to operate a first data communication with the server, and wherein the second computer program product is executable on the second internet enabled wireless mobile device to operate a second data communication with the server, and

wherein the first computer program product is executable on the first internet enabled wireless mobile device to use a built-in camera or external camera interfacing with first mobile device to take multiple images of the face, head or object in near proximity in front of the built-in camera or external camera interfacing with first mobile device and to convert the camera data into a digital signal in a 2D matrix area of n times 2D images, to form 3D data, and with a colour per dot to form 4D data and to transmits that 4D data as first data through the first data communication channel to the internet enabled server device, the internet enabled server device executing the third computer program product to store the first data on a server non-transitory storage medium, and

wherein the second computer program product is executable on the second internet enabled wireless mobile device to use a built-in camera or external camera interfacing with second mobile device to take multiple images of the face, head or object in near proximity in front of the built-in camera or external camera interfacing with second mobile device and to convert the camera data into a digital signal in a 2D matrix area of n times 2D images to form 3D data, and with a colour per dot to form 4D data and to transmit that 4D data as second data through the second data communication channel to the internet enabled server device, the internet enabled server device executing the third computer program product to store the second data on a server non-transitory storage medium, and

wherein in the event the third computer program product executing on the internet enabled server device detects data received from the first internet enabled wireless mobile device or from the second internet enabled wireless mobile device, the data received is stored in the server non-transitory storage medium and is indexed such that each data is associated to a respective originating user account of the first internet enabled wireless mobile device user or the second internet enabled wireless mobile device user, for further processing.

An advantage is improved security through the use of processed multiple camera images.

According to a fourth aspect of the invention, there is provided a system including a first internet enabled wireless mobile device with a built-in microphone, speaker and camera and at least a second internet enabled wireless mobile device with a built-in microphone, speaker and camera, and at least one internet enabled server device, wherein;

the first internet enabled wireless mobile device includes a first non-transitory storage medium, and a first computer program product embodied on the first non-transitory storage medium, the first computer program product executable on the first internet enabled wireless mobile device such that the first internet enabled wireless mobile device communicates with the server, and

the second internet enabled wireless mobile device includes a second non-transitory storage medium, and a second computer program product embodied on the second non-transitory storage medium, the second computer program product executable on the second internet enabled wireless mobile device such that the second internet enabled wireless mobile device communicates with the server, and

the internet enabled server device including a third non-transitory storage medium, and a third computer program product embodied on the third non-transitory storage medium, wherein the third computer program product is executable on the internet enabled server device, such that the internet enabled server device communicates with at least the first internet enabled wireless mobile device and/or the second internet enabled wireless mobile device, and

wherein the first computer program product is executable on the first internet enabled wireless mobile device to operate a first data communication with the server, and wherein the second computer program product is executable on the second internet enabled wireless mobile device to operate a second data communication with the server and,

wherein the first computer program product is executable on the first internet enabled wireless mobile device to use a built-in camera or an external camera interfacing with the first mobile device to take one or multiple images of the eyes of a subject in near proximity in front of the built-in camera or the external camera interfacing with the first mobile device and to converts the camera data into a digital representation of (i) diameters of the iris and/or pupil in horizontal, vertical, and n times diameters at angles between horizontal and vertical and/or (ii) the area of the iris and/or pupil and/or (iii) the colour of the iris and/or pupil and/or the sclera and to transmit that digital representation as first data through the first data communication channel to the internet enabled server device, the internet enabled server device executing the third computer program product to store the first data on a server non-transitory storage medium, and wherein the second computer program product is executable on the second internet enabled wireless mobile device to use a built-in camera or external camera interfacing with second mobile device to take one or multiple images of the eyes of a subject in near proximity in front of the built-in camera or external camera interfacing with second mobile device and to convert the camera data into a digital representation of (i) diameters of the iris and/or pupil in horizontal, vertical, and n times diameters at angles between horizontal and vertical and/or (ii) the area of the iris and/or pupil and/or (iii) the colour of the iris and/or pupil and/or the sclera and to transmit that digital representation as second data through the second data communication channel to the internet enabled server device, the internet enabled server device executing the third computer program product to store the second data on the server non-transitory storage medium, and

wherein in the event the third computer program product executing on the internet enabled server device detects data received from the first internet enabled wireless mobile device or from the second internet enabled wireless mobile device, the data received is stored in the server non-transitory storage medium and is indexed such that each data is associated to a respective originating user account of the first internet enabled wireless mobile device user or the second internet enabled wireless mobile device user, for further processing.

An advantage is improved security through the use of processed one or multiple camera images of the eyes of a subject.

The system may be one wherein each of the first internet enabled wireless mobile device and the second internet enabled wireless mobile device are a mobile phone, a smartphone, a wireless tablet Computer, a MiFi device, or an Internet of Things (IoT) device.

The system may be one wherein the first data and the second data stored in the server non-transitory storage medium is processed by the server computer program in the following steps;
(i) in the event of a user login to the server of the first internet enabled wireless mobile device and/or the second internet enabled wireless mobile device, comparing the received first data and/or the received second data with all past stored data on the server non-transitory storage medium of the respective first or second user account, and if a data match is found of “n %” or higher then allow such login, and if a data match is found of “m %” or lower, then do not allow such login, and where “m” is equal or less than “n”,
(ii) in the event of a transaction considered critical by a user of the first internet enabled wireless mobile device and/or the second internet enabled wireless mobile device, comparing the received first data and/or the received second data with all past stored data on the server non-transitory storage medium of the respective first or second user account, and if a data match is found of “n %” or higher then allow such transaction considered critical to be executed by the server, and if a data match is found of “m %” or lower then do not allow such transaction considered critical to be executed by the server, and where “m” is less than “n”,
(iii) in the event of a user new account creation of the first internet enabled wireless mobile device and/or the second internet enabled wireless mobile device, comparing the received first data and/or the received second data with all past stored data on the server non-transitory storage medium of all existing users, blacklisted images and attempted but rejected account creation users, and if a data match is found of “n %” or higher then blacklist and reject a new account opening to that user, and if a data match is found of “m %” or lower, then do allow such new account creation, and where “m” is equal or less than “n”.

The system may be one wherein the first data and the second data stored in the server non-transitory storage medium is processed by the server computer program in the following steps;
a.—separate the incoming first data and the incoming second data and the stored data in the server non-transitory storage medium by “x” groups of colours or colour gradients, thus creating an additional indexing per “colourgroup” per user account wherein two adjacent colourgroups could have the same user in one group (user1.colourgroup1) and in the adjacent group (user1.colourgroup2), and
b.—assign the colour indexing per user account, in example user1 index=colourgroup 1 and colourgroup2 and users 2 index=colourgroupX and coulourgroupX-1, and
c.—in the event of a user login of the first internet enabled wireless mobile device and/or the second internet enabled wireless mobile device, comparing the received first data and/or the received second data with all past stored data on the server non-transitory storage medium of each such first or second user account BUT only comparing the data of the same colourgroup(s), and if a data match is found of “n %” or higher then allow such login, and if a data match is found of “m %” or lower, then do not allow such login, and where “m” is equal or less than “n”,
d.—in the event of a transaction considered critical by a user of the first internet enabled wireless mobile device and/or the second internet enabled wireless mobile device, comparing the received first data and/or the received second data with all past stored data on the server non-transitory storage medium of each such first or second user account BUT only comparing the data of the same colourgroup(s), and if a data match is found of “n %” or higher then allow such transaction considered critical to be executed by the server, and if a data match is found of “m %” or lower, then do not allow such transaction considered critical to be executed by the server, and where “m” is equal or less than “n”,
e.—in the event of a user new account creation of the first internet enabled wireless mobile device and/or the second internet enabled wireless mobile device, comparing the received first data and/or the received second data with all past stored data on the server non-transitory storage medium of all existing users, blacklisted images and attempted but rejected account creation users BUT only comparing the data of the same colourgroup(s), and if a data match is found of “n %” or higher then blacklist and reject a new account opening to that user, and if a data match is found of “m %” or lower, then do allow such new account creation, and where “m” is equal or less than “n”,
f.—and/or wherein
(i) a rectangle “A” is defined of a size of “Z” wide by “X2” high, wherein “Z” is the distance from the centre of left pupil to the centre of right pupil and wherein the rectangle “A” is the area that starts from a distance of “X1” above the centre of the left or right pupil upwards, and
(ii) a rectangle “B” is defined of a size of “Z” wide by “Y2” high, wherein “Z” is the distance from the centre of left pupil to the centre of right pupil and wherein the rectangle “B” is the area that starts from a distance of “Y1” below the centre of the left or right pupil, and
(iii) wherein the image(s) data of area “A” of a predefined time T1−x (before T1=before eye closing) is compared with the image(s) data of area “A” of a predefined time T2+y (after T2, after eye opening), and
(iv) wherein the image(s) data of area “B” of a predefined time T1−x (before T1) is compared with the image(s) data of area “B” of a predefined time T2+y (after T2), and (vi) wherein in the event the change in percentage of the image(s) of A and/or B before T1 (T1−x) compared to images of A and/or B respectively after T2 (T2+y) as defined previously is higher than g % then the eye blinking is considered as fraudulent and no further interaction is allowed by that user with any user account.

The system may be one wherein the first data and the second data stored in the server non-transitory storage medium is processed by the server computer program in the following steps;
a.—separate the incoming first data and the second data and the stored data in the server non-transitory storage medium by two groups of images, a “group_before” of “b” images before the eye starts blinking (closing) and a “group_after” of “a” image(s) after the eye opened per incoming data per user account and
b.—detect and store the time the eyes of the user closed from start of blinking as time T1, until the eyes start to open or end of blinking as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are compared with each other and if a data match is found of “n %” or higher then allow such action (account creation or login or other) to be executed by the server (subject, person or animal is considered alive), and if a data match is found of “m %” or lower, then do not allow such action to be executed by the server (subject, person or animal is considered alive), and
g.—wherein “m” is equal or less than “n”.

The system may be one wherein the first data and/or the second data stored in the server non-transitory storage medium is processed by the server computer program in the following steps;
a.—separate the incoming first data and the second data and the stored data in the server non-transitory storage medium by two groups of images, a “group_before” of “b” images before the bright light starts and a “group_after” of “a” image(s) after the dark light starts, incoming data per user account and
b.—detect and store the images of the time the first or second computer program product embodied on the first or second non-transitory storage medium of the first or second internet enabled wireless mobile device, respectively, starts a bright light as time T1, until the bright light ends and dark light starts as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are used to calculate the percentage diameter and/or area change of the iris and/or pupil, and/or
g.—wherein the image(s) of “group_before” and “group_after” are used to calculate the percentage change of colour of the iris and/or pupil and/or sclera, and
h.—if in previous step “f.-” or step “g.-” a percentage change of before vs after is found to be of “n %” or higher is detected then allow such action (account creation or login or other) to be executed by the server (subject, person or animal is considered alive), and if percentage change of before vs after is found to be of “m %” or lower, then do not allow such action to be executed by the server (subject, person or animal is considered alive), and
i.—wherein “m” is less than “n.

The system may be one wherein the first data and the second data stored in the server non-transitory storage medium is processed by the server computer program in the following steps;
a.—separate the incoming first data and the second data and the stored data in the server non-transitory storage medium by two groups of images, a “group_before” of “b” images before the bright light starts and a “group_after” of “a” image(s) after the dark light starts incoming data per user account and
b.—detect and store the images of the time the first or second computer program product embodied on the first or second non-transitory storage medium of the first or second internet enabled wireless mobile device, respectively, starts showing a small object as time T1, until the time it starts showing that same object very big (close to full screen size) as time T2, wherein between T1 and T2 there are no measurements during this timeframe other than establishing T1 and T2, and
c.—the system sets a parameter “x” in milli-seconds to establish the time “T1−x” and uses that as the time period of input data to consider in “group_before” and
d.—the system sets a parameter “y” in milli-seconds to establish the time “T2+y” and uses that as the time period of input data to consider in “group_after”, and
e.—wherein x<y, and
f.—wherein the image(s) of “group_before” and “group_after” are used to calculate the percentage diameter change of the iris and/or pupil, and/or
g.—wherein the image(s) of “group_before” and “group_after” are used to calculate the percentage change of colour of the iris and/or pupil, and
h.—if in previous step “f.-” or step “g.-” a percentage change of before vs after is found to be of “n %” or higher is detected then allow such action (account creation or login or other) to be executed by the server (subject, person or animal is considered alive), and if percentage change of before vs after is found to be of “m %” or lower, then do not allow such action to be executed by the server (subject, person or animal is considered alive), and
i.—wherein “m” is less than “n.

According to a fifth aspect of the invention, there is provided a computer-implemented method including using a first internet enabled wireless mobile device with a built-in microphone, speaker and camera and at least a second internet enabled wireless mobile device with a built-in microphone, speaker and camera, and at least one internet enabled server device, wherein:

the first internet enabled wireless mobile device includes a first non-transitory storage medium, and a first computer program product embodied on the first non-transitory storage medium, the first computer program product executable on the first internet enabled wireless mobile device such that the first internet enabled wireless mobile device communicates with the server, and

the second internet enabled wireless mobile device includes a second non-transitory storage medium, and a second computer program product embodied on the second non-transitory storage medium, the second computer program product executable on the second internet enabled wireless mobile device such that the second internet enabled wireless mobile device communicates with the server, and

the internet enabled server device, including a third non-transitory storage medium, and a third computer program product embodied on the third non-transitory storage medium, the third computer program product executable on the internet enabled server device such that the internet enabled server device communicates with at least the first internet enabled wireless mobile device and/or the second internet enabled wireless mobile device, and

wherein the first computer program product executes on the first internet enabled wireless mobile device to operate said first data communication with the server, and wherein the second computer program product executes on the second internet enabled wireless mobile device to operate said second data communication with the server and, wherein the first computer program product when executing on the first internet enabled wireless mobile device uses the speaker to emit a frequency in the audible and/or inaudible human ear spectrum and the microphone receives the audio waves bounced back from the face, head or object in near proximity of the first mobile device and converts the analogue signal into a digital signal and transmits the digital signal as first data through the first data communication channel, the internet enabled server device executing the third computer program product to store the first data on a server non-transitory storage medium, and

wherein the second computer program product when executing on the second internet enabled wireless mobile device uses the speaker to emit a frequency in the audible and/or inaudible human ear spectrum and the microphone receives the audio waves bounced back from the face, head or object in near proximity of the second mobile device and converts the analogue signal into a digital signal and transmits the digital signal as second data through the second data communication channel, the internet enabled server device executing the third computer program product to store the second data on the server non-transitory storage medium, and

wherein in the event the server computer program executing on the internet enabled server device detects data received from the first internet enabled wireless mobile device or from the second internet enabled wireless mobile device, the data is stored in the server non-transitory storage medium and is indexed such that each data is associated to the corresponding originating user account of the first internet enabled wireless mobile device user or second internet enabled wireless mobile device user, for further processing. An advantage is improved security through the use of emitted, measured and stored audio data.

According to a sixth aspect of the invention, there is provided a computer-implemented method including using a first internet enabled wireless mobile device with a built-in microphone, speaker and camera and at least a second internet enabled wireless mobile device with a built-in microphone, speaker and camera, and at least one internet enabled server device, wherein:

the first internet enabled wireless mobile device includes a first non-transitory storage medium, and a first computer program product embodied on the first non-transitory storage medium, the first computer program product executable on the first internet enabled wireless mobile device such that the first internet enabled wireless mobile device communicates with the server, and

the second internet enabled wireless mobile device including a second non-transitory storage medium, and a second computer program product embodied on the second non-transitory storage medium, the second computer program product executable on the second internet enabled wireless mobile device such that the second internet enabled wireless mobile device communicates with the server, and

the internet enabled server device, including a third non-transitory storage medium, and a third computer program product embodied on the third non-transitory storage medium, the third computer program product executable on the internet enabled server device such that the internet enabled server device communicates with at least the first internet enabled wireless mobile device and/or the second internet enabled wireless mobile device, and

wherein the first computer program product is executable on the first internet enabled wireless mobile device to operate said first data communication with the server, and wherein when the second computer program product is executable on the second internet enabled wireless mobile device to operate said second data communication with the server and,

wherein the first computer program product when executed on the first internet enabled wireless mobile device uses a frequency transceiver or transducer built-in or externally interfacing with the first mobile device to emit frequency patterns and to receive the frequency waves bounced back from the face, head or object in near proximity of the frequency transceiver or transducer built-in or externally interfacing with the first mobile device and to convert the analogue signal into a digital signal and to transmit the digital signal as first data through the first data communication channel to the internet enabled server device executing the third computer program product to store the first data on a server non-transitory storage medium, and

wherein the second computer program product when executed on the second internet enabled wireless mobile device uses a frequency transceiver or transducer built-in or externally interfacing with the second mobile device to emit frequency patterns and to receive the frequency waves bounced back from the face, head or object in near proximity of the frequency transceiver or transducer built-in or external interfacing with the second mobile device and to convert the analogue signal into a digital signal and to transmit the digital signal as second data through the second data communication channel to the internet enabled server device executing the third computer program product to store the second data on the server non-transitory storage medium, and wherein in the event the server computer program executing on the internet enabled server device detects data received from the first internet enabled wireless mobile device or second internet enabled wireless mobile device, the data is stored in the server non-transitory storage medium and is indexed such that each data is associated to the corresponding originating user account of the first internet enabled wireless mobile device user or second internet enabled wireless mobile device user, for further processing. An advantage is improved security through the use of transmitted frequency patterns, and measured and stored bounced back data.

According to a seventh aspect of the invention, there is provided a computer-implemented method including using a first internet enabled wireless mobile device with a built-in microphone, speaker and camera and at least a second internet enabled wireless mobile device with a built-in microphone, speaker and camera, and at least one internet enabled server device, wherein:
the first internet enabled wireless mobile device includes a first non-transitory storage medium, and a first computer program product embodied on the first non-transitory storage medium, the first computer program product executable on the first internet enabled wireless mobile device such that the first internet enabled wireless mobile device communicates with the server, and

the second internet enabled wireless mobile device includes a second non-transitory storage medium, and a second computer program product embodied on the second non-transitory storage medium, the second computer program product executable on the second internet enabled wireless mobile device such that the second internet enabled wireless mobile device communicates with the server, and

the internet enabled server device, with a third non-transitory storage medium, and a third computer program product embodied on the third non-transitory storage medium, the third computer program product executable on the internet enabled server device such that the internet enabled server device communicates with at least the first internet enabled wireless mobile device and/or the second internet enabled wireless mobile device, and

wherein the first computer program product is executable on the first internet enabled wireless mobile device to operate said first data communication with the server, and wherein when the second computer program product is executable on the second internet enabled wireless mobile device to operate said second data communication with the server and,

wherein the first computer program product when executed on the first internet enabled wireless mobile device uses a built-in camera or external camera interfacing with the first mobile device to take multiple images of the face, head or object in near proximity in front of the built-in camera or external camera interfacing with first mobile device and converts the camera data into a digital signal in a 2D matrix area of n times 2D images forming the 3D data and with a colour per dot to form the 4D data and transmits that 4D data as first data through the first data communication channel to the internet enabled server device executing the third computer program product to store the first data on a server non-transitory storage medium, and

wherein the second computer program product when executed on the second internet enabled wireless mobile device uses a built-in camera or external camera interfacing with second mobile device to take multiple images of the face, head or object in near proximity in front of the built-in camera or external camera interfacing with second mobile device and converts the camera data into a digital signal in a 2D matrix area of n times 2D images forming the 3D data and with a colour per dot to form the 4D data and transmits the 4D data as second data through the second data communication channel to the internet enabled server device executing the third computer program product to store the second data on the server non-transitory storage medium, and wherein in the event the server computer program executing on the internet enabled server device detects data received from the first internet enabled wireless mobile device or from the second internet enabled wireless mobile device, the data is stored in the server non-transitory storage medium and is indexed such that each data is associated to the corresponding originating user account of the first internet enabled wireless mobile device user or second internet enabled wireless mobile device user, for further processing. An advantage is improved security through the use of processed multiple camera images.

According to an eighth aspect of the invention, there is provided a computer-implemented method including using a first internet enabled wireless mobile device with a built-in microphone, speaker and camera and at least a second internet enabled wireless mobile device with a built-in microphone, speaker and camera, and at least one internet enabled server device, wherein;

the first internet enabled wireless mobile device includes a first non-transitory storage medium, and a first computer program product embodied on the first non-transitory storage medium, the first computer program product executable on the first internet enabled wireless mobile device, such that the first internet enabled wireless mobile device communicates with the server, and the second internet enabled wireless mobile device including a second non-transitory storage medium, and a second computer program product embodied on the second non-transitory storage medium, the second computer program product executable on the second internet enabled wireless mobile device such that the second internet enabled wireless mobile device communicates with the server, and

the internet enabled server device, with a third non-transitory storage medium, and a third computer program product embodied on the third non-transitory storage medium, the third computer program product executable on the internet enabled server device such that the internet enabled server device communicates with at least the first internet enabled wireless mobile device and/or the second internet enabled wireless mobile device, and

wherein the first computer program product is executable on the first internet enabled wireless mobile device to operate said first data communication with the server, and wherein the second computer program product is executable on the second internet enabled wireless mobile device to operate said second data communication with the server and,

wherein the first computer program product when executed on the first internet enabled wireless mobile device uses a built-in camera or external camera interfacing with first mobile device to take one or multiple images of the eyes of the subject in near proximity in front of the built-in camera or external camera interfacing with first mobile device and converts the camera data into a digital representation of (i) the diameters of the iris and/or pupil in horizontal, vertical, and n times diameters at angles between horizontal and vertical and/or (ii) the area of the iris and/or pupil and/or (iii) the colour of the iris and/or pupil and/or the sclera and transmits the digital representation as first data through the first data communication channel to the internet enabled server device executing the third computer program product to store the first data on a server non-transitory storage medium, and

wherein the second computer program product when executed on the second internet enabled wireless mobile device uses a built-in camera or external camera interfacing with second mobile device to take one or multiple images of the eyes of the subject in near proximity in front of the built-in camera or external camera interfacing with second mobile device and converts the camera data into a digital representation of (i) the diameters of the iris and/or pupil in horizontal, vertical, and n times diameters at angles between horizontal and vertical and/or (ii) the area of the iris and/or pupil and/or (iii) the colour of the iris and/or pupil and/or the sclera and transmits that digital representation as second data through the second data communication channel to the internet enabled server device executing the third computer program product to store the second data on the server non-transitory storage medium, and

wherein in the event the server computer program detects data received from the first internet enabled wireless mobile device or second internet enabled wireless mobile device, the data is stored in the server non-transitory storage medium and is indexed such that each data is associated to the corresponding originating user account of the first internet enabled wireless mobile device user or second internet enabled wireless mobile device user, for further processing. An advantage is improved security through the use of processed one or multiple camera images of the eyes of a subject.

The fifth aspect of the invention may be implemented on a system of any aspect of the first aspect of the invention. The sixth aspect of the invention may be implemented on a system of any aspect of the second aspect of the invention. The seventh aspect of the invention may be implemented on a system of any aspect of the third aspect of the invention. The eighth aspect of the invention may be implemented on a system of any aspect of the fourth aspect of the invention.

Aspects of the invention may be combined.

### BRIEF DESCRIPTION OF THE FIGURES

Aspects of the invention will now be described, by way of example(s), with reference to the following Figures, in which:

FIGS. 1A and 1B are a typical example of the present invention, represented as a diagram of our method, or system including system components.

FIG. 2 is an example of the present invention, depicted as a functional flow-chart of our system or method.

FIG. 3 represents a flow-chart of a typical example of the prior art.

FIG. 4 represents a flow-chart of a typical example of the present invention, wherein the prior art of FIG. 3 is included and where all the new added parts of the flow-chart are specific to novelty of the method or system of an example of this invention.

FIG. 5 is a schematic representation of a method of an example of this invention to get data through waves, to capture data of “shapes/objects/faces/full head of a person all around” using the speaker and microphone or a wave/frequency transceiver built-in the devices used or interfaced from the device to an external wave/frequency transceiver.

FIG. 6 shows an example graphical representation of the shapes of the captured data, before the artificial intelligence (AI) of an example of this invention converts them into dots' map. AI of an example of this invention obtains 3D data captured by processing every n-times Z axis a 2D representation and merging all the n-times 2D representations as a 3D data representation as shown in this figure. FIG. 6 shows a representation of a face example captured by waves.

FIG. 7A represents a cartesian diagram, in which in the prior art the faces or points are processed in 2D, in which the points are biometric ID points.

FIG. 7B represents a cartesian diagram, where the faces or points are processed, in which the points are biometric ID points, and in our system or method of an example of this invention they are depicted in 3D or 4D; in this last case 4D is obtained by adding the colour as the 4th dimension to a 3-dimensional representation thus becoming a 4D representation.

FIGS. 8 to 10 represent three representation diagrams of typical examples of the present invention, wherein the pupil and/or iris and/or sclera change of size and/or area and/or colour is obtained in 3 different methods (before & after-blinking, light change or object size change respectively), and calculated in 2 different ways (multiple angle diameters way and/or absolute area way). FIG. 8 shows an example eye blinking method. FIG. 9 shows an example light exposure method. FIG. 10 shows an example object focus method.

### DETAILED DESCRIPTION

In an example, since the information to be processed is directly related to the depth, it is much more practical to collect the data in 3 dimensions directly with the methods and systems of examples of this invention, thus losing much less information during the processing cycles and achieving more accurate results.

Examples of our invention overcome the above shortcomings, in one of the examples of the present invention, by reducing the false positives compared to the prior art and increasing the different methods used to correlate the liveness of a person by light exposure and simulating far and close objects exposure and eye blinking exposure on delta in diameter, area or colour of the before and after multiple different angle diameter sizes and/or the actual area of the iris and/or pupil(s) and/or sclera of the person and/or the colour of the iris and/or Pupil(s) and/or sclera as a much more reliable less invasive method and/or system for liveness detection. The sclera, also known as the white of the eye or, in older literature, as the tunica albuginea oculi, is the opaque, fibrous, protective outer layer of the human eye containing mainly collagen and some crucial elastic fiber.

An example of this invention is particularly suited, in case of registering a new user or adding a new object/shape/animal/person's representation to a 3D or 4D database (4D is a 3D plus colour as the 4th dimension), a process where the necessary information will be obtained by making several image captures or alternatively, by means of waves emitted and subsequently collected by the device (similar to the Doppler effect principle), optionally by means of sound waves with the speaker and microphone of the device and additionally optimal by adding a 4th dimension to the data obtained and stored, wherein the 3D representation would be a simultaneously processed X, Y, Z axis data plus adding a colour scale (C) for each point in the matrix and storing the data in 4D once processed as X, Y, Z, C.

The first data will be collected directly in 3D, to which an extra dimension for the colour is added, after a data collision process. As a result, the information stored in the database can be used directly for a 4D digital representation.

In addition, and independently, examples of this invention methods and systems allow for a life detection test during the data obtaining process, adding information, very relevant to the legal and security aspect, in the profile of the person to be registered or in semi- or real-time to obtain at regular time-intervals new input data and detect the person is still the same person and is alive/awake/responsive in critical uses-cases.

An example of the invention is a system and method for capturing 3D or 4D-dimensional (3D or 4D) data on the shape or figure of a person, animal or object through the use of a device, in example but not limited to a mobile, wireless device, laptop or desktop computer with at least one camera, speaker and microphone or alternatively a wave/frequency transceiver built-in. These devices, according to examples of this invention are a unit that can operate independently or send the collected data for processing to a local or remote processing different to the previous mentioned device according to the system, methods and/or flowcharts or drawings of examples of this invention with the aim of capturing the data of the geometric shape of a person, animal or object. The aspects of disclosures refer, in particular, to a system and method that are able to obtain relevant information about the shape of the surface of objects, people, animals, or any figure that may be within range of the camera's focus or alternatively within the range of receiving the bounce back signal emitted from the device's speaker or wave/frequency transmitter reflected off the person, animal or object. The methods that are collected here have two clear objectives, the first, to give the possibility of introducing any shape or figure of real life to the virtual world, empowering the average user to recreate them in a digital format in a simple way, without having to own expensive or ultra-high-quality devices that tend to be even more expensive. Secondly, to provide greater possibility of legal protection to companies related to the virtual world identification systems, providing useful methods against to combat or reduce digital fraud on identity forgery, such as life detection and facial identification, aspects of disclosure that focus on the fact that the techniques, methods and systems developed and described in examples of this invention for obtaining information through the devices adapted as per examples of this invention are herein described, meaning the system(s) and/or method(s) herein can confirm or deny the existence of life in the shapes, figures or images extracted by such devices, which is crucial information to detect if a person or animal is alive for security situations and confirm or deny the person, animal or object are the same as an existing one in the database also for security reasons, for law enforcement, for account access security protection, for potential transactions identification purposes, for missing persons search, for crime prevention or crime solving purposes, for example.

In an example of this invention, contrary to the state of the art, the raw data is extracted directly in three dimensions, that is to say, in addition to the 2-dimensional position, the depth is obtained as the 3rd dimension or 3rd axis. Therefore, it is not necessary to process the data after obtaining the data to find the information of the third axis, this simultaneous 3-dimensional data extraction and processing of the 3-dimensional data in one go is being one of the novelties of examples of this invention as a method and system.

Depth is considered of vital importance, amongst other reasons for the simple fact of being able to differentiate the volume of the object to be processed, and this is precisely one of the shortcomings of the state of the art, as their workflow is to obtain information through the processing of images, which is information in two dimensions. One of the methods that are developed in examples of this invention and that overcomes this shortcoming is the use of waves emitted by the device itself and the reception of the bounced back signals from the person/animal/object, similar to the Doppler effect applied on obtaining a 3rd axis as the same time as obtaining the 2-dimensional image axes. In this case, this method is performed with the device's speaker and microphone or alternatively through a wave/frequency transceiver or transducer built-in the device, as one of the various options that this method conceives.

The waves impact any shape or object that is within reach of said device, creating the rebound wave, which will be the reading of the data to be processed. The difference in time and shape between both waves (emitted and received) will be processed to build the definition of the surface shape of the captured object, shape or person.

In an example, once the required 3D information (images 2 axis XY plus the distance 3rd axis Z) has been collected, an artificial intelligence (AI) network is used to transform the data into the format best understood by the system. The AI learning can be done in various ways, such as in a so called “supervised way”, that is, during training, the AI ensures that the input data to the network is correctly labelled, or in a “unsupervised learning way”, where the AI network learns to classify the different input data depending on their properties, without having any label. In the same way, the AI network has to be trained with multiple inputs of different objects, shapes, figures, images, animals or people which the AI system is able to classify them per groups of related items and such data which the AI network and/or method and/or system described in examples of this invention will process. This AI network, once it classifies and identifies, in a generic way, the input data, it will be able to reorganize those points, that due to various interferences, such as but not limited to external noise or any loss of information, have not been properly collected. Thus, improving the definition and precision of the stored information to allow to make a statistically higher possibility of the recreation of that figure, form or shape, image, animal or person as faithful as possible to perceived reality.

The representation of the person, animal or object is made in an example of this invention thanks to the format of the way the data is collected and consequently stored, this is, having the information in a digital form directly in 3 or 4 dimensions, by creating a space of 3 axes or 3 axes plus a colour as the 4th dimension per each data input point, where the data can be positioned having referenced each of the axes and thus building the body representation of that relevant object, shape, figure, animal or person.

In the state of the art, the representation of the information is not as trivial as in the case of examples of this invention presented herein, since it is based on a list or set of data in 2 dimensions where the information obtained from said person processed is collected, in each of the different angles or positions previously used.

It is therefore a clear shortcoming of the state of the art, because it does not have a direct simultaneous depth parameter at time of data collection, prior to the processing of the data, in addition to there is another shortcoming of requiring more storage capacity and more data processing, since the information to be processed must already been collected prior and be available in a saved memory space.

The process in the state of the art can have several developmental pathways, however, they all have a common shortcoming, namely that all the information that is collected is through the image captured from a camera of the device, be it the 2D data or the depth data to get through an additional processing to obtain the 3D data. The methods of the state of the art can be divided into two main groups, (i) those that perform the capture of the image with the common camera of devices, and (ii) those that perform it with the infrared camera that is available in the device in relation to this data capture method.
(i)—Those who implement the commonly used camera pathway perform image recognition with a facial recognition network, however, in order to obtain data on the depth of said person, it needs multiple captures to be made and processed by taking common reference points, which is a shortcoming that examples of our invention have overcome.
(ii)—The other alternative uses the infrared camera, which needs an infrared light emitter to reproduce a series of bursts of light on the person, for the distance data to be processed. With this method, and after processing the image obtained with infrared light, the device is able to calculate the depth or volume, if the light conditions are optimal or potentially when favourable, which is a shortcoming that examples of our invention have overcome.

In a different example of the present invention, the data collected by this example of our invention are not intended for the shape, object, animal or person 2D, 3D or 4D data image to be reproduced, simply, in one example it seeks to make a detection of life in the processed data person or animal, specifically intended for people liveness checks. This check is typically carried out in online new user account registrations, session starts, or online purchases, or in safety situations as a so called Deadman kill switch for trains or other vehicles among other uses, where, in addition to performing a facial recognition, to verify the veracity of the person's identification, a life detection is sought to ensure that, for example, it is not an image or a photograph of the recognized person used by someone pretending to be someone else or that the person is still awake or responsive is critical functions as train drivers or race pilots or airplane pilots.

In the state of the art, the most common way to perform this check is to ask for a sequence of positions, to be able to process the movement, correct or not, of the corresponding person, however, this method shortcoming involves a high cost of processing resources, having to multiply the number of images to be processed, at the same time as requiring a very higher amount of storage space. Also, in safety sensitive use case as for drivers of vehicles or airplanes or such other cases where the person cannot be distracted from its main task of driving the vehicle or performing any such other critical function. That is why, this shortcoming requires a different solution, namely checking for the existence of depth and volume in detected faces, thus being able to differentiate the images or photographs from a real person. That method in the prior art requires an infrared camera and an infrared light emitter, both incorporated into the devices used. It includes emitting light in various ways to capture its reflection, with the infrared camera sensor which is not required in some examples of this invention.

In a different example of the present invention, a method of life detection of an object, figure, animal or person is developed which is based on detecting physical changes between the different captures made, especially in the difference in size of the iris of the person, caused by a decisive increase in the reception of direct light. In addition to introducing this new method, in yet another different example of the present invention, an extra dimension is introduced in the storage of the captured data, by adding the colour parameter in each point that forms the data set.

In another example of the present invention, a further method to combat fraud is added, and by adding the extra dimension of colour to the captured data, it is possible to work with one more parameter to adjust the facial recognition process. The example described here using this method is based on the different facial structures that exist depending on the colour of people's skin, and powerful filters can be created to group the data. Therefore, the amount of processing to be carried out is greatly minimized, avoiding the manipulation of a large amount of data in face comparisons, since it would be carried out with a smaller number of users.

In yet another different example of the present invention the liveness of the person is improved by detecting fraudulent use of static photos or other methods by fraudsters by this example of the invention method and/or system of detection of the eyes in multiple frames of a video or multiple photos wherein the person is exposed to a light intensity change with a wavelength that affects the size of the iris of the eye and/or the pupil and/or the sclera and comparing the frames/photos before and after the light exposure to one or both eyes by detecting and calculating the area and/or diameter in multiple rotating angles to compensate for the non-perfect circular shape of the iris and/or pupil and/or sclera of the eye(s). For example, with an increase in light brightness, the pupils will shrink in order to reduce the amount light to enter by reducing the exposed area of the pupil to the brighter light and thus the diameter will reduce accordingly. However, as pupils and/or iris of the eyes are not a perfect circle, the imperfections that distort the calculation of diameter are resolved in examples of this invention by a method and system that compares each diameter before and after light exposure on different rotating angles, in example diameter horizontal, diameter vertical, diameter in “n” different angles in between. If it were a perfect circle then a single diameter would have been enough but nothing is perfect. Similarly, since the iris and/or pupil is not a perfect circle a method and system of calculating the area as a mathematical approximation of surface improves the accuracy of the actual area of the iris and/or pupil before and after the light exposure. Changes in diameter or surface area of the iris and/or pupil and/or sclera are then used to correlate to people on the video frames or photos from before and after a light exposure to determine if they are alive or not. The multiple frames used in our method allows for some frames with eyes closed to compare before and after the eye closing the diameter and pupil and/or iris size/area AND by our method and/or system changing the size of an object which the person is looking at on a screen (in example, a smartphone) as it would also change the size of the pupil, as the pupil and/or iris become smaller for objects that are near (big) and become bigger when objects are far (smaller). This method and system of this example of the invention has applications for both security of accounts but also for safety of certain professions and for medical applications for early detection of potential eye illnesses that correlate to changes in close or far sight vision change or light sensitiveness vision change or pupil/iris/sclera colour change.

Examples of the present invention are designed to solve real issues in people's lives, such as (i) improving the security of people's digital assets to protect them from fraudulent activities by other people's unlawful acts or scams, (ii) protect the identity of individuals in the digital world by securing user accounts across the entire virtual spectrum where users store items of electronic value, (iii) reduce the exposure of potential fraud done to users of a given system/platform or potential fraud on an account of a given system to a user of the same or a different system/platform, (iv) recreating figures/objects from the real world in the virtual world, e.g. the metaverse, or any such other online platform such as online banking-, payments- or products sales platforms. (v) reducing the potential false users' identities in online platforms login and platform use and at the same time increasing the security of user's online accounts or new accounts creations by improving liveness detection methods.

In summary, the previous real issues in people's lives are solved, in addition to providing solutions to problems faced by companies offering services in the digital world, such as preventing fraud among users, identity fraud, fraudulent user access, legal protection, etc.

Examples of the present invention are designed to overcome the shortcomings of the prior art and to provide an automated way of resolving the shortcomings of the prior art specifically in the prevention and detection of potential identity fraud on the internet.

Such method and system, in one example, are based on access given by users to the camera and infrared sensor hardware of the device. In another example they are based on the access given by the users to the hardware of the speaker and microphone or alternatively a wave/frequency transceiver built-in, complying with the requirements of an example of this invention, or the third person has used the “application software” of an example of this invention in order to benefit from (e.g. all) the benefits of examples of this invention.

The devices herein are fixed- or wireless-devices, smartphones, tablets, portable- or desktop-computers and any such other different devices that have a camera, or a speaker and microphone or alternatively a wave/frequency transceiver built-in and can download the application software of an example of this invention or has it built-in by the manufacturer and are adapted to communicate with the cloud hardware and cloud application software of an example of this invention.

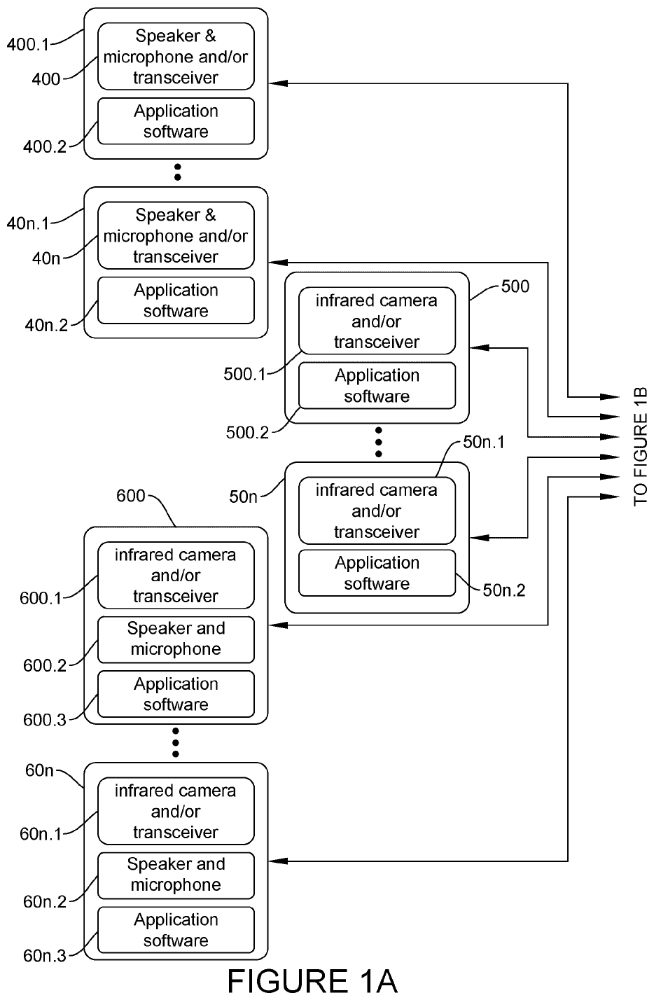

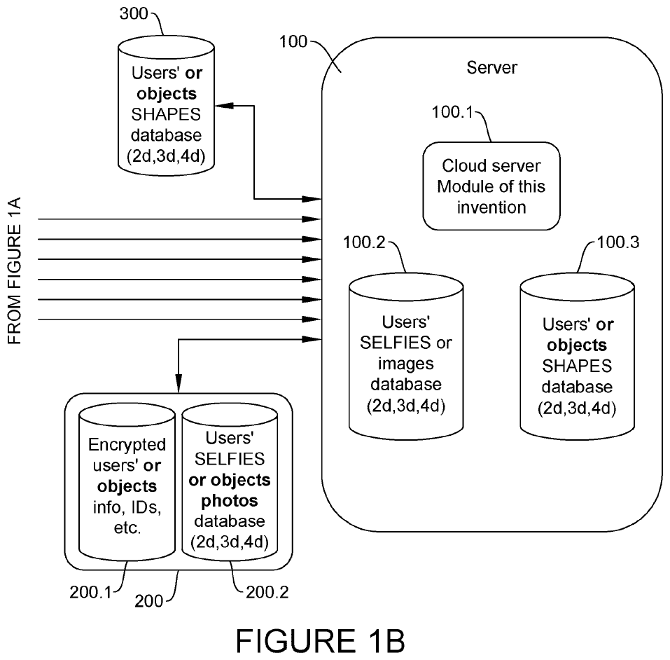

Specifically, FIGS. 1A and 1B are a typical example of the present invention, depicted as a diagram of the top-level components of our system or method. Where, the devices 400 to 40n are internet enabled devices (in example a smartphone) with built-in speaker and microphone. Potentially a transceiver could be used instead of the microphone and loudspeaker, in example a transducer transmitter and receiver of ultrasound or other wave frequencies outside of the human audible range.

Devices 500 to 50n are internet enabled devices with a built-in infrared camera as a receiver and transmitter. Potentially a transceiver could be used instead of the infrared camera, in example a transceiver (transmitter and receiver) of light or other light wave frequencies inside or outside of the human visible range.

Devices 600 to 60n are devices with a built-in infrared camera and transmitter, speaker and microphone (or any such previously mentioned wave/frequency transceiver). All these devices have access to the Internet and can be devices such as smartphones, tablets, laptops (PCs), notebooks and so on.

All of them are the different devices with which to carry out examples of this invention's novelties. Depending on the properties of the device, the “proprietary application software” shown in the figure(s) as “application software” for short, automatically autoconfigures the device to execute one method or another.

Parts of the device's hardware, such as the camera or the speaker and microphone (or any wave/frequency transceiver), are controlled by the application software of an example of this invention (provided the device user having given the device's required permissions beforehand), wherein the application software can be pre-embedded at factory or embedded in a 3rd party software application as a software development kit (SDK) or downloaded through the internet into a device (400 to 600). Alternatively, the application software of an example of this invention could be executed remotely or in a browser-based application software.

The application software of an example of this invention provides the different options for capturing information, either through waveforms or images processing.

In the use-case where the system or method of an example of this invention captures the information through images, the general use case is the use of so-called face recognition or in detection of liveness. Thus, the application software sets the quality of the picture to be taken or the quality of the video to be taken wherefrom the pictures are extracted from the frames and potentially would draw a blurred watermark on the screen leaving a clear vertical oval space where the user has to put his face when taking his “selfie” or “video” (e.g. the user himself takes a picture or video of his full face by pressing the take picture or start/stop video key).

Furthermore, if the liveness detection is activated, a different example of this invention system or method would test the user in one or more of the following three methods, for example, whilst the user is looking at the device screen,
(i) changing the illumination of the device screen from a very dark colour to a very bright light colour screen and vice-versa, in order to capture the change in iris and/or pupil diameter or area size or change in colour of the pupil and/or iris and/or sclera of one or both of the user's eyes when the screen was very dark compared to when the screen was in bright light, and/or
(ii) changing the size of an object or shape on the screen of the device from a very small to a very big size of the same object or shape and vice-versa, in order to capture the change in iris and/or pupil diameter or area size or change in colour of the pupil and/or iris and/or sclera of one or both of the user's eyes when the object was small (simulating an object in far distance) compared to when the object was big (simulating an object in close distance), and/or
(iii) by detecting the eye blinking of one or both eyes and comparing the change in iris and/or pupil diameter or area size or change in colour of the pupil and/or iris and/or sclera of one or both of the user's eyes of a time of before the eye started blinking compared to a time of after the eye opened after blinking.

The captured data is sent to the server (100), where the proprietary “Cloud server module of an example of this invention” (100.1) is to process the data into a format required for further processing or decision taking by the server module (100.1) and/or by the device's proprietary software applications (400.2 to 40n2, 500.1 to 50n.2, 600.1 to 60n.3). Then it compares the processed image (in example a selfie or a frame of a video) with the users' database (100.2). After that, the image (selfie photo or video frame) will be compared against the image (selfie photo or video frame) in the database called “Users' SELFIES or objects photos database (2d image, 3d image, 4d image, the 4d being the 3d with colour adding as the 4th dimension)” (200.2), wherein the selfies or objects photos are images originated from captured photos or images from frames of videos in both cases captured by one or more of the devices 400.1 to 40n.1 or 500 to 50n or 600 to 60n.

When a match is detected of an incoming image (selfie photo or video frame) with any other image in the databases (100.2), meaning matching above the minimum level of correlation but below a set level 1 (for example above the minimum of 70% match but less than in example 75%, which is level 1 in this example) then the system or method shall not allow the user of the originating device of that image to create a new account or to log into any existing account of the platform or system. However, if the image match is equal or more than level 1 match percentage (for example equal or higher than in example 75%) then the proprietary cloud server module of an example of this invention (100.1) automatically completes the process to connect the corresponding user device with the account of that user or to create a new account, linking the user with any account associated to any image in the database that matches with the incoming image.

Similarly, the previous is applicable when instead of an image a shape is extracted by a device and provided to the system server module (100.1), where instead in this use case the system server will use for its calculation purposes by 100.1 the database 100.2 instead.

In a different example, the database (100.2) of an example of this invention is fed by selfies or images from 3rd parties compliant to the applicable privacy regulation, extracting the face from an image as the selfie.

In a different example, the “Cloud server Module of an example of this invention” (100.1) could be used as an external processor linked to a 3rd parties' system, compliant with its own 3rd party system (200) with its own “Encrypted users or objects' info, IDs, etc.” (200.1) and its own “Users' SELFIES or objects photos/images database (2d,3d,4d)” (200.2) against which to compare selfies or images or shapes captured by the devices (400 to 600) or by the 3rd party devices of system (200).

In yet another example of the present invention when using the devices (400 to 600) speaker and microphone (or any wave/frequency transceiver) to capture the data, in this case, the main objective is to capture the shape of the surface of the object/person focused by the device (400 to 600) and store it in “Users' SHAPES database (2d,3d,4d)”.

Therefore, the user will have to move his device (400 to 600) around his face or full head until the system captures its entire shape.

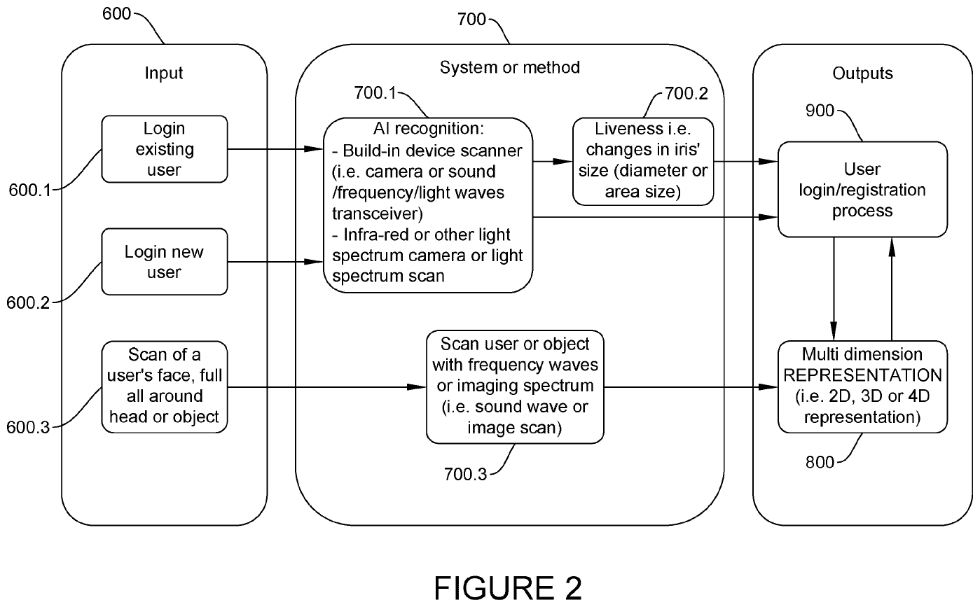

FIG. 2 represents a functional flow-chart or diagram of a typical example of the present invention. The main things required for a typical example are the following inputs (600) for a security Access to a digital physical or online account;
(i) existing account registration (600.1), and
(ii) a new account registration (600.2), and
(iii) user data capture (600.3).

The system or methods (700) used is mainly for use cases related with security, liveness and face recognition, wherein the diagram of (700) shows the AI recognition block (700.1) having received the input data (600.1 or 600.2)) from an existing or new user login, followed thereafter by the liveness' proof block (700.2) only for new users or existing high-risk users, ending up in a decision by “the login/register process” module (900). This last (900) not only takes into account the previous decisions by (700.1) and/or (700.2) but will also take into account in certain cases (i.e., users considered high risk) the “2D, or 3D or 4D representation” (800) of that input user (600.1 or 600.2) if that information is available for that user.

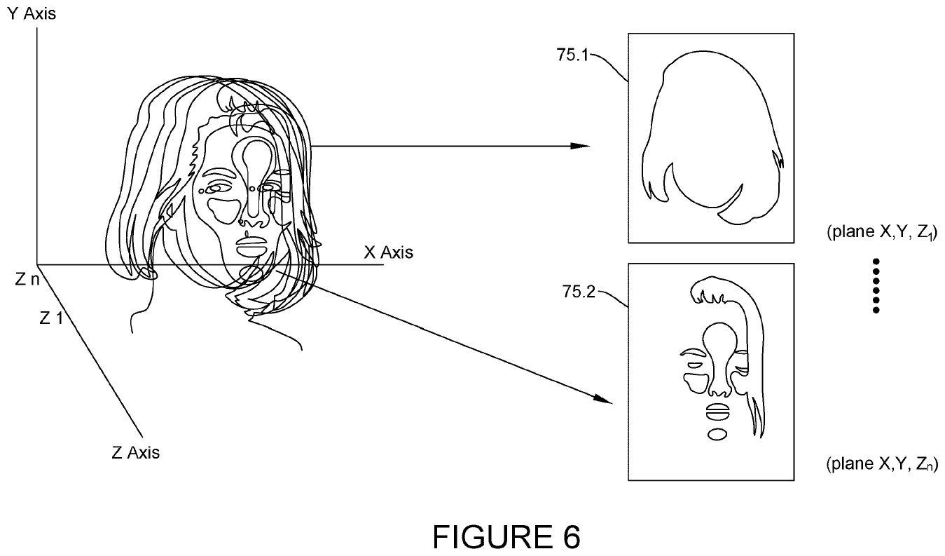

The 2D, 3D or 4D representation of (800) is obtained by requesting or forcing a scan of a user face, head or object as an input (300), which the system or method of an example of this invention will use, for example through frequency waves or imaging spectrum (700.3) to process the data captured by input (600.3), and which can be with an example of this invention represented in a multidimension way (800) in 2d,3d or 4d. Actually, one of an example of this invention's methods take the data captured in 3D by (600.3) and processes it in (700.3) as 3D data and represents it in (800) as a 3D representation or as a 4D representation by (700.3) adding colour as the 4th dimension thus representing it in 4D, or alternatively changes the flow as follows;
(900) decides based on the additional info from (800) wherein (800) receives the data from (700.3) as the resulting processed data it took from the data captured in 2D as “X,Y” axis data by (600.3) as a matrix for every n-times in the Z axis and processes it in (700.3) as 2D data and represents it in (800) as a 3D representation by representing all the n times “D processed data as a Y axis matrix thus forming the 3D representation (it's like putting the 2D slices with only X, Y on top of each other as Z1, Z2, . . . . Zn slices forming a matrix of X, Y,Z1 to X, Y,Zn), see also FIG. 6, or as a 4D representation by (700.3) adding colour as the 4th dimension thus representing it in 4D.

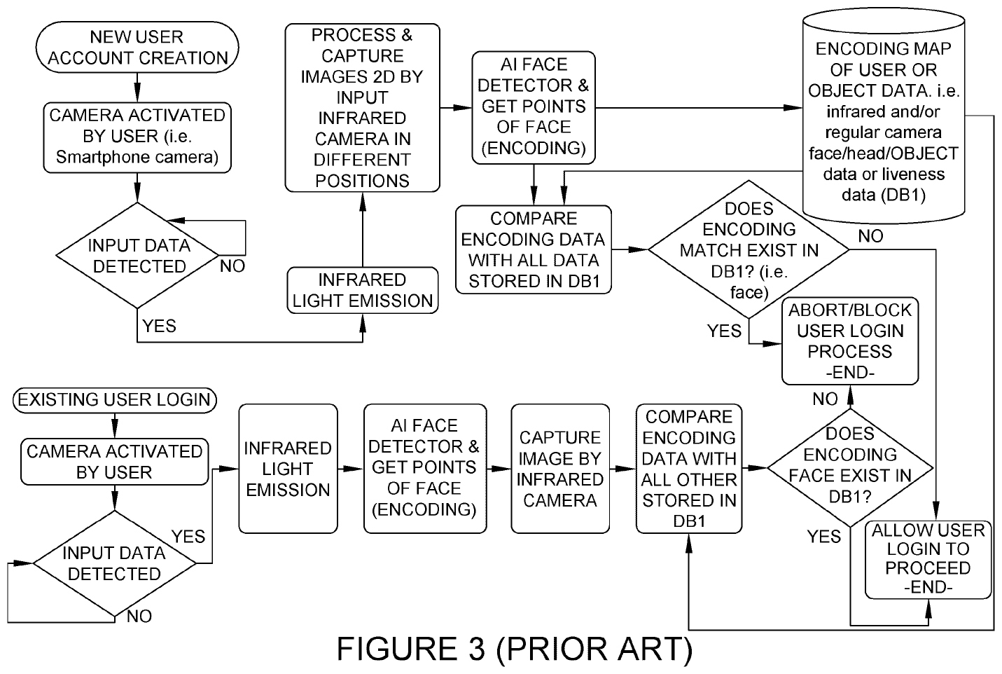

FIG. 3 represents a flow-chart of a typical example of the prior art, representing most of the methods used by the different prior art to perform facial recognition, mainly in order to control identity fraud in the physical or online digital world. In the prior art, the methods used involve a system that determines if the identity of a user is true or false, by processing 2 dimensional images, captured by a standard camera or by a built-in infrared camera such as in smartphones.

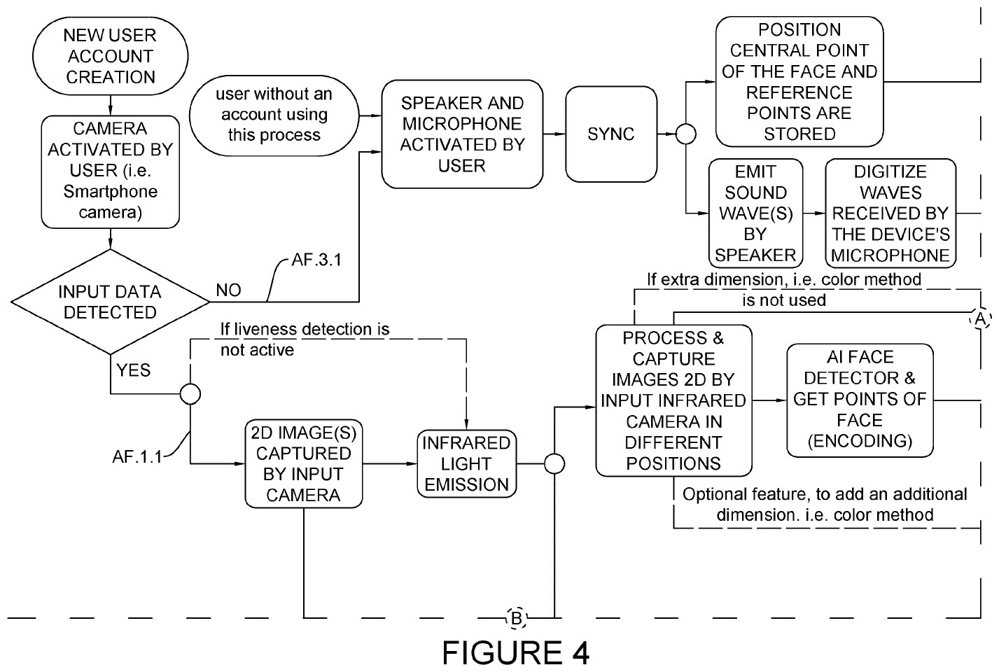

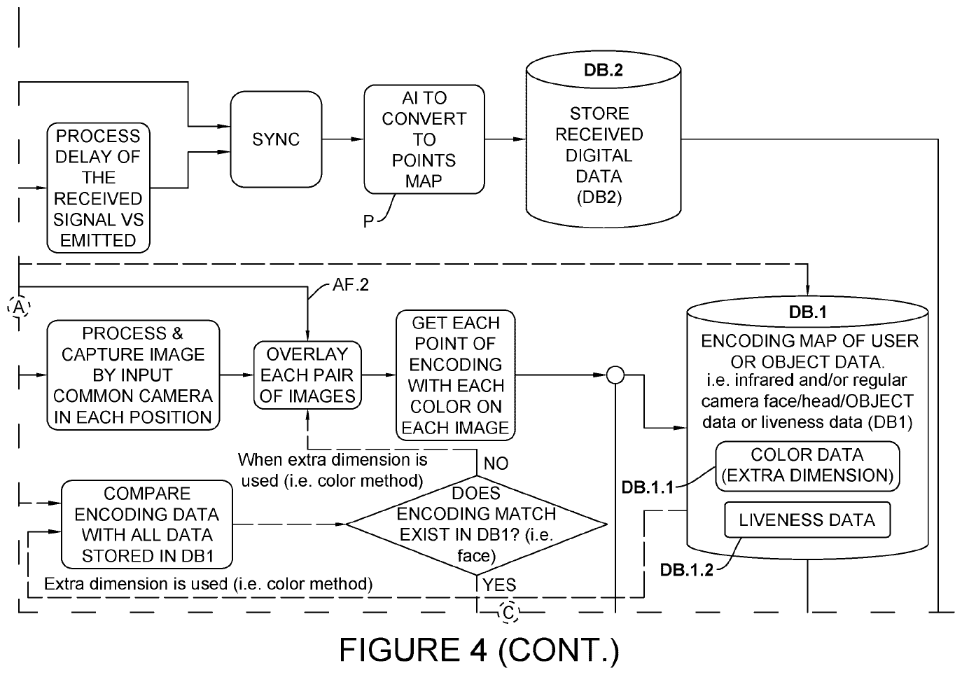

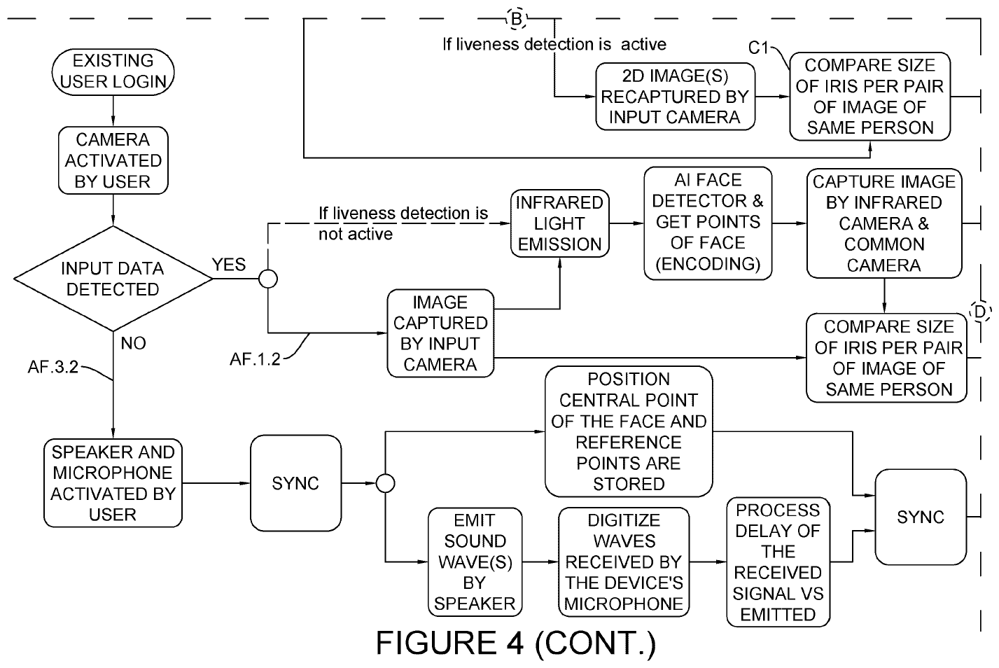

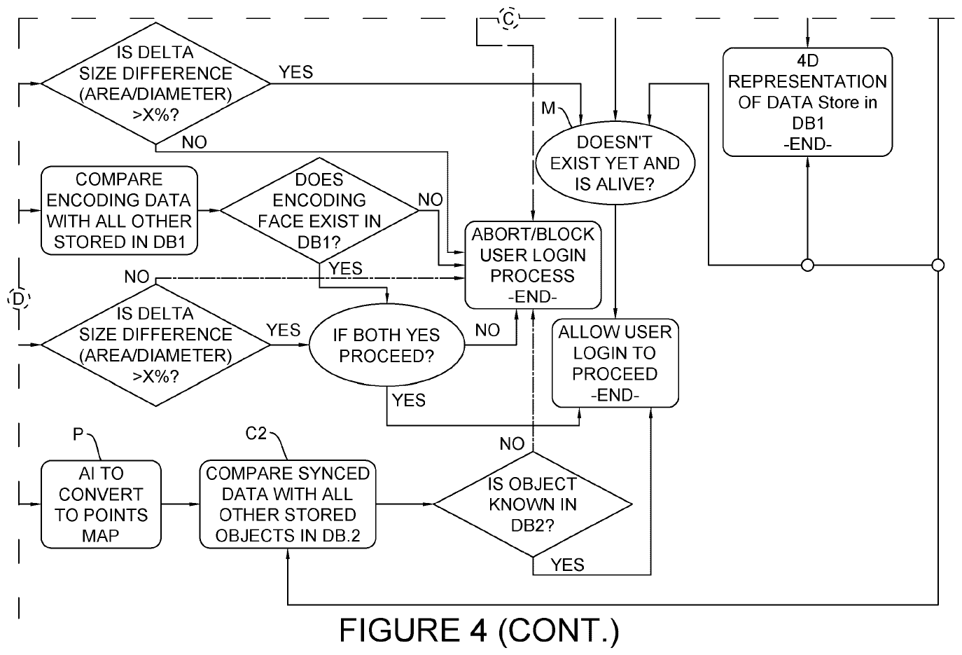

FIG. 4 represents a flow-chart of a typical example of the present invention, wherein the prior art of FIG. 3 is shown as is and where all the new added parts of an example of this invention are highlighted. The new parts of an example of this invention are divided into two clearly differentiated parts;

(i) an example of this invention adds another three complementary methods (AF.1.1), (AF1.2) and (AF.3.2) to the prior art, and adding an additional security check in the process flow with (C1) and (C2), and, on the other hand, it adds colour to the captured data to improve the representation of the same, wherein the prior art database DB.1 is adapted adding the extra 4th dimension as well as the proprietary results of the liveness test of an example of this invention, adding those respectively within the sub-databases (DB.1.1) and (DB.1.2), where the 4D data created are stored in (DB.1).

In an example of this invention, the decision to allow a user login or new registration or to block the user from accessing his account (or parts of the functions of his account) or creating an account is made by module (M), which takes into account the inputs of the proprietary liveness detection of an example of this invention and the proprietary facial recognition of an example of this invention.

The other method added by an example of this invention is the use of the speaker and microphone (or waves/frequency trans-receiver), shown as (AF.3.2), which provide the information to decide in the compare module (C2), after having transformed the data into a readable format through the conversion module (P), to know if this person already exists in DB.2 or DB.1.

In a different example of the present invention (AF.3.1) allows for a user access without an account, to use this system or method by capturing his data, and saving it in (DB.2) and which will then be used as an additional input to module (C2) to decide if such user data that later on entered through (AF.3.2) is allowed to proceed with login or a certain system function or to create a new account or is blocked from doing so.

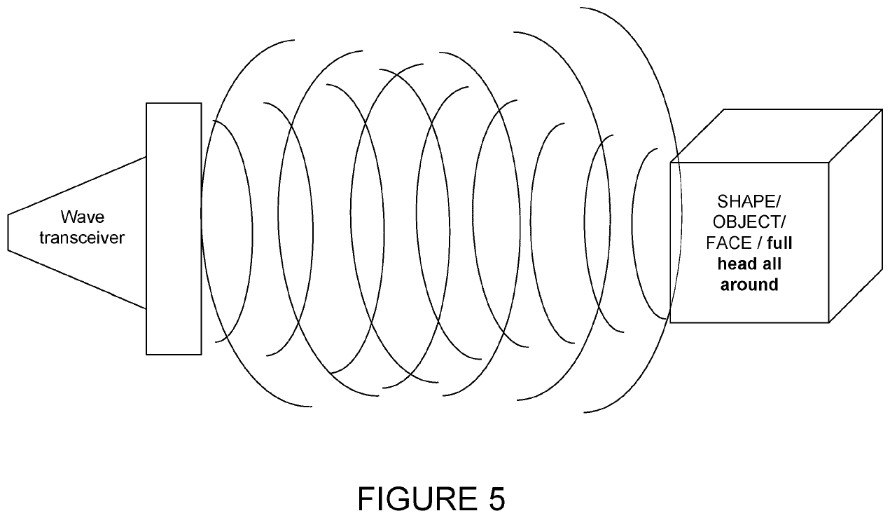

FIG. 5 graphically represents the method used to capture the 3D data of shapes/objects/persons using the speaker and microphone (or wave/frequency transceiver) of a device as described in an example of this invention. This method is based on the bouncing of waves on different surfaces, be it very different than the Doppler effect, the principles of a Doppler effect have been adapted such as to allow the resulting data to be processed as a 2D representation in matrix form, thus forming a 3D representation or directly processing the adapted received input data as 3D data representation, see FIG. 6.

FIG. 6 represents a cartesian diagram, as a graphical representation of the shapes of the captured data, before the proprietary Artificial intelligence (AI) of an example of this invention converts them into dots on a two-dimensional map. The AI of an example of this invention obtains 3D data in two different ways:
(i) by capturing directly 3D data and processing it as a 3D representation, or
(ii) the preferred method of an example of this invention, by capturing the data in 2D and processing in 2D every slice in a matrix form. Meaning processing n-2D images (Z axis divided by n) or in other words if n=75 then there would be 75 “2D images”, thus processing the 75 images in 2D and storing the 75 images indexed as to allow to represent them in the correct order to form the 3D representation or merging all the 75 processed 2D images and store it as a 3D data files for direct 3D representation. In the figure, two of the 75 (n) slices (2D images) can be seen respectively as (75.1 and 75.2) as shown in this figure and where (75.1) is the first 2D image where the dimensional n is in two axes X, Y and where (75.2) is the last 2D image where the dimensional is in two axes X, Y and where the Z axis is represented by every different 2D image having been extracted on a different Z dimension, namely Z1 for the first 2D image=X,Y,Z1 and Zn for the last 2D image=X, Y,Zn.

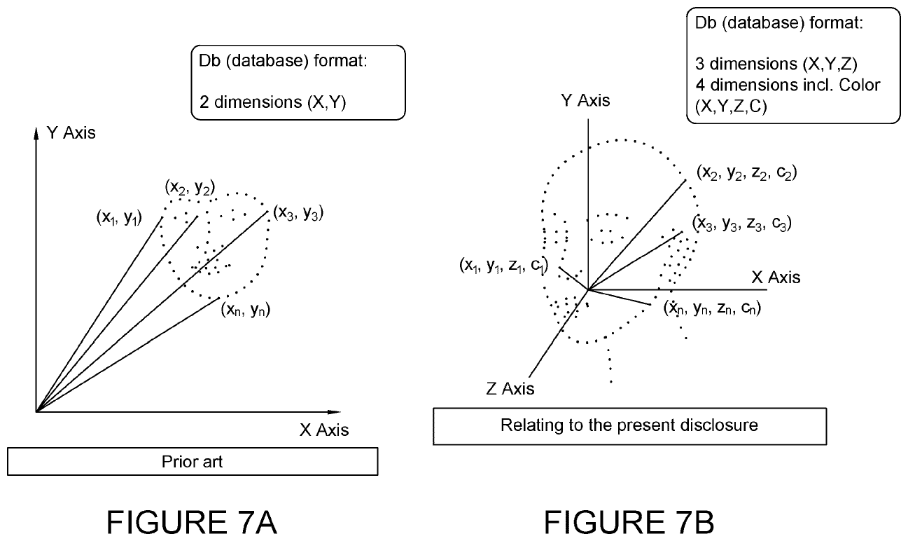

FIG. 7A represents a cartesian diagram, where in the prior art, a user's face is processed as distances from a single origin point as X,Y axes points and are then processed accordingly in 2D. FIG. 7B represents a cartesian diagram, showing the representation of an example of this invention system or method where single origin is identified and set within the target area (in example an easy to identify spot of a face, such as a point of the nose) and from which 3 dimensional data in 3 axes X,Y,Z is extracted and processed accordingly in 3D or alternatively, a colour is added to each point as the 4th axis, thus resulting in 4 dimensional representation as X,Y,Z,C.

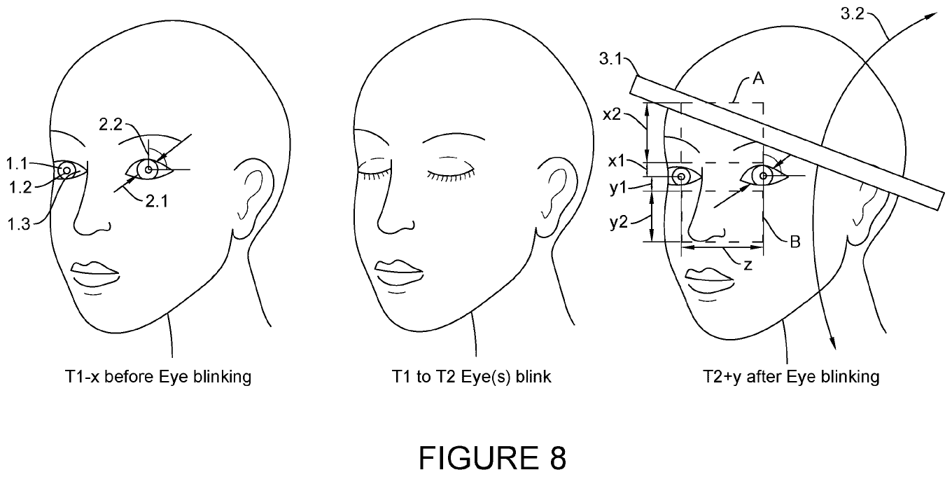

FIGS. 8 to 10 represent three representation diagrams, which can be used in isolation or in combination of two of them or all three together. FIGS. 8 to 10 show the different methods or system of examples of this invention to detect and calculate the variation in area size or in diameter (2.1) of the “iris” (1.1), outer circle of the eye, and/or identify the colour group(s) of the iris but more importantly the colour group(s) and/or diameter (2.2) of the “pupil” (1.2), inner circle of the eye, which lets more light though when it's bigger and less light though when it's smaller and/or the colour group(s) of the sclera (1.3). In an example or examples:
a pupil gets smaller when it is exposed to very bright light (e.g. when exiting a tunnel with sun outside) to reduce the amount of light it lets through, or when focusing on an object that is near, and
a pupil gets bigger when it is exposed to very dark light (e.g. when entering a tunnel) to increase the amount of light it lets through, or when focusing on an object that is far;
a subject (person or animal) eye colour (iris and/or pupil and/or sclera colour) does not change over a reasonably short period of time but rather in certain stages in life or for health reasons thus in another example is used to determine if the person is alive or is even the same person or not.

FIG. 8 shows in the middle the eyes of the user closed from start of blinking, time T1, until the eyes start to open or end of blinking, time T2, there are no measurements during this timeframe other than establishing T1 and T2. FIG. 8 on the left shows one or both eyes open before the time “T1” and the system of an example of this invention sets a parameter “x” in milli-seconds to establish the time “T1−x” and uses that as input data to calculate the diameter of the iris and/or the pupil and/or the absolute area of both and/or the colour group(s) of the iris and/or the pupil and/or the sclera. The Diameter of the pupil being the preferred method of an example of this invention wherein multiple diameters are extracted starting the horizontal one and n number of more diameters on different angles between horizontal and vertical, to allow for eye lids that may potentially cover part of the top and/or bottom of the eye. FIG. 8 on the right it shows one or both eyes open after the time “T2” and the system of an example of this invention sets a parameter “y” in milli-seconds to establish the time “T2+y” and uses that as input data to calculate the diameter of the iris and/or the pupil and/or the absolute area of both and/or the colour group(s) of the iris and/or the pupil and/or the sclera. The system and method of examples of this invention will then compare the percentage change of the diameter and/or area of the pupil and/or iris to establish the liveness of the subject or user, and the percentage change of the colour groups as well. Alternatively, the data extracted of change in the colour of the pupil and/or iris and/or sclera, and/or the change in diameter and/or area of the iris and/or pupil could be used to find correlations to certain medical eye diagnosis.

The preferred method of an example of this invention is where time parameter “y” is smaller than parameter “x”, meaning measure the size of the pupil x milli-seconds before the eyes closed, for data in memory at time T1−x and is expected to be the biggest size of the pupil's diameter when exposed to natural light and some from a regular smartphone screen, compared to the diameter of the pupil immediately after opening the eye(s) after blinking when the eye was exposed to little light with closed eyes and before the pupils start to dilate (shrink because of light exposure when opening the eyes), thus the pupil size is smaller immediately after opening the eyes (T2+y) than before the blinking at time (T1−x), meaning “y” has to be absolute minimum possible to take the input right before the eyes even have the time to shrink the pupil due to light exposure right after opening the eyes after blinking.

Furthermore, in yet another different example of the present invention, on the right of FIG. 8 it shows a visual representation of;
(i) the rectangle “A” of a size of “Z” wide by “X2” high, wherein “Z” is the distance from the centre of left pupil to the centre of right pupil and wherein the rectangle “A” is the area that starts from a distance of “X1” above the centre of the left or right pupil upwards, and
(ii) the rectangle “B” of a size of “Z” wide by “Y2” high, wherein “Z” is the distance from the centre of left pupil to the centre of right pupil and wherein the rectangle “B” is the area that starts from a distance of “Y1” below the centre of the left or right pupil, and
(iii) wherein the image(s) data of area “A” of a predefined time T1−x (before T1) is compared with the image(s) data of area “A” of a predefined time T2+y (after T2), and
(iv) wherein the image(s) data of area “B” of a predefined time T1−x (before T1) is compared with the image(s) data of area “B” of a predefined time T2+y (after T2), and
(vi) wherein in the event the change in percentage of the image(s) of A and B before T1 compared to images of A and B after T2 as defined previously is higher than n % then the system and method herein considers the eye blinking as fraudulent, in example simulated by a person by moving a ruler 3.1 from the top to the bottom of the face and/or vice versa (see 3.2), in which case the before blinking images on T1−x would show the ruler in area A before blinking detection (eyes closed) and not after blinking at T2+y and likely would show the ruler in area B in images of T2+y after blinking detection (eyes) but not in images of area B at T1−x, meaning the ruler could appear on area A or B but could appear in area A and B in which case the percentage of change of images would be even double as much, but even one ruler in area A or B would be detected with this system or method.

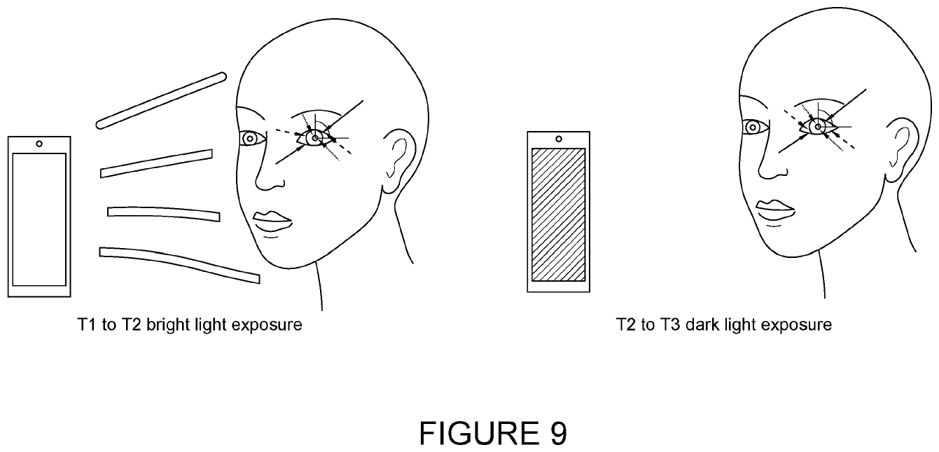

FIG. 9 shows on the left the eyes of the user exposed to bright light emitted by a device close to his face in example a smartphone screen. Bright light exposure is from time T1 to time T2 and then switches from bright to dark light exposure shown on the right. Similar as in previous FIG. 8 here the input data timing is key when it is extracted for processing. Input data of T2−x to calculate diameter of pupil with screen bright light exposure and data of T3−y to calculate diameter of pupil with screen darkness exposure. In this case however “y” could be in one example of this invention the same as “x” because the measurements need to be done at the last possible time in each cycle of bright or dark screen to allow the pupil to adapt to that light exposure, meaning just before switching from bright to dark to calculate the pupil diameter in bright light and just before switching from dark to anything else or ending the exposure to calculate the pupil diameter in bright light. The diameter of the pupil in dark light will be then n % bigger than the diameter of the same pupil in bright light. In a different example of the present invention the starting exposure can be by dark light and then switch to bright light as the % variation of pupil size may vary in one direction compared to the other. In yet another variant of the present invention the bright light may be originated by a different wavelength light, still within the visible range of the human or animal eye, depending on the subject, meaning for a cat a different wavelength could be used than for humans or in some case a flash of a smartphone could be used as the bright light on the left of FIG. 9 and natural light as the dark light on the right of FIG. 9 because the bigger the difference in light brightness the better the human eyes react to pupil diameter and/or area size changes.

In a different example of the present invention the percentage change of the actual colour or colour groups or colour range of the iris and/or the pupil and/or the sclera can be collected before and after the exposure of a bright light transition to a dark light or/and the transition from a dark light to a bright light.

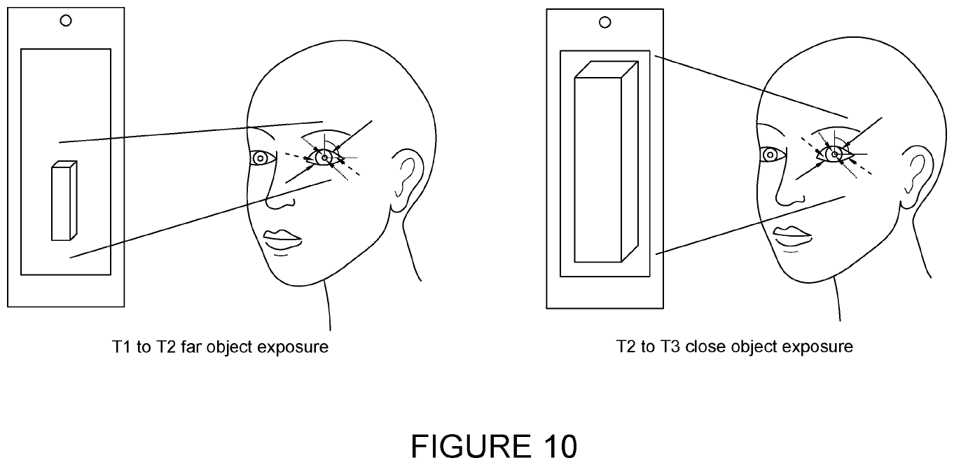

FIG. 10 shows on the left the eyes of the user exposed to a small object, simulating an object at a far distance, by a device close by (in example a smartphone) and FIG. 10 shows on the right, the eyes of the user exposed to a relatively big object, simulating an object at a very close distance. Similar as in previous FIG. 9 case the time frames when the input data is used is identical, x milli-seconds before switching from small to big object size and y milli-seconds after switching to big size (or x milli seconds before ending the big object exposure. The diameter of the pupil will be n % bigger when focusing on a small object (far) than when focusing on a big object (close). In a different example of the present invention the percentage change of the actual colour or colour groups or colour range of the iris and/or the pupil and/or the sclera can be collected after the exposure of a far object transition to a near object or/and the transition from a near object to a far object.

### Concepts

1. A system including a first internet enabled wireless mobile device with a built-in microphone, speaker and camera and at least a second internet enabled wireless mobile device with a built-in microphone, speaker and camera, and at least one server, wherein;

the first internet enabled wireless mobile device, a first non-transitory storage medium, and a first computer program product embodied on the first non-transitory storage medium, the first computer program product executable on the first internet enabled wireless mobile device when executed communicates with the server, and

the second internet enabled wireless mobile device, a second non-transitory storage medium, and a second computer program product embodied on the second non-transitory storage medium, the second computer program product executable on the second internet enabled wireless mobile device when executed communicates with the server, and

the internet enabled server device, with a third non-transitory storage medium, and a third computer program product embodied on the third non-transitory storage medium, the third computer program product executable on the internet enabled server device when executed communicates with at least the first and/or second internet enabled wireless mobile device, and

wherein the first computer program product is executable on the first internet enabled wireless mobile device to operate said first data communication with the server, and wherein the second computer program product is executable on the second internet enabled wireless mobile device to operate said second data communication with the server and,

wherein the first computer program product when executed on the first internet enabled wireless mobile device uses the speaker to emit a frequency in the audible and/or inaudible human ear spectrum and the microphones receives the waves bounced back from the face, head or object in near proximity of the first mobile device and converts the analogue signal into a digital signal and transmits that first data through the first data communication channel to the server computer program and server transitory storage medium, and

wherein the second computer program product when executed on the second internet enabled wireless mobile device uses the speaker to emit a frequency in the audible and/or inaudible human ear spectrum and the microphones receives the waves bounced back from the face, head or object in near proximity of the second mobile device and converts the analogue signal into a digital signal and transmits that second data through the second data communication channel to the server computer program and server transitory storage medium, and

wherein in the event the server computer program detects data received from the first or second internet enabled wireless mobile device, the data is stored in the server transitory storage medium indexed such that each data is associated to the originating user account of the first or second internet enabled wireless mobile device user, for further processing.

2. A system including a first internet enabled wireless mobile device with a built-in microphone, speaker and camera and at least a second internet enabled wireless mobile device with a built-in microphone, speaker and camera, and at least one server, wherein; the first internet enabled wireless mobile device, a first non-transitory storage medium, and a first computer program product embodied on the first non-transitory storage medium, the first computer program product executable on the first internet enabled wireless mobile device when executed communicates with the server, and the second internet enabled wireless mobile device, a second non-transitory storage medium, and a second computer program product embodied on the second non-transitory storage medium, the second computer program product executable on the second internet enabled wireless mobile device when executed communicates with the server, and

the internet enabled server device, with a third non-transitory storage medium, and a third computer program product embodied on the third non-transitory storage medium, the third computer program product executable on the internet enabled server device when executed communicates with at least the first and/or second internet enabled wireless mobile device, and

wherein when the first computer program product is executable on the first internet enabled wireless mobile device to operate said first data communication with the server, and wherein when the second computer program product is executable on the second internet enabled wireless mobile device said second data communication with the server and,

wherein the first computer program product when executed on the first internet enabled wireless mobile device uses a frequency transceiver or transducer that emits frequency patterns and receives the frequency waves bounced back from the face, head or object in near proximity of the frequency transceiver or transducer built-in or external interfacing with first mobile device and converts the analogue signal into a digital signal and transmits that first data through the first data communication channel to the server computer program and server transitory storage medium, and

wherein the second computer program product when executed on the second internet enabled wireless mobile device uses a frequency transceiver or transducer that emits frequency patterns and receives the frequency waves bounced back from the face, head or object in near proximity of the frequency transceiver or transducer built-in or external interfacing with second mobile device and converts the analogue signal into a digital signal and transmits that second data through the second data communication channel to the server computer program and server transitory storage medium, and wherein in the event the server computer program detects data received from the first or second internet enabled wireless mobile device, the data is stored in the server transitory storage medium indexed such that each data is associated to the originating user account of the first or second internet enabled wireless mobile device user, for further processing.

3. A system including a first internet enabled wireless mobile device with a built-in microphone, speaker and camera and at least a second internet enabled wireless mobile device with a built-in microphone, speaker and camera, and at least one server, wherein; the first internet enabled wireless mobile device, a first non-transitory storage medium, and a first computer program product embodied on the first non-transitory storage medium, the first computer program product executable on the first internet enabled wireless mobile device when executed communicates with the server, and the second internet enabled wireless mobile device, a second non-transitory storage medium, and a second computer program product embodied on the second non-transitory storage medium, the second computer program product executable on the second internet enabled wireless mobile device when executed communicates with the server,

and the internet enabled server device, with a third non-transitory storage medium, and a third computer program product embodied on the third non-transitory storage medium, the third computer program product executable on the internet enabled server device when executed communicates with at least the first and/or second internet enabled wireless mobile device, and

wherein the first computer program product is executable on the first internet enabled wireless mobile device to operate said first data communication with the server, and wherein the second computer program product is executable on the second internet enabled wireless mobile device said second data communication with the server, and wherein the first computer program product when executed on the first internet enabled wireless mobile device uses a built-in camera to take multiple images from the face, head or object in near proximity in front of the built-in camera or external camera interfacing with first mobile device and converts the camera data into a digital signal in a 2D matrix area of n times 2D images forming the 3D data and with a colour per dot forming the 4D data and transmits that first data through the first data communication channel to the server computer program and server transitory storage medium, and wherein the second computer program product when executed on the second internet enabled wireless mobile device uses a built-in camera to take multiple images from the face, head or object in near proximity in front of the built-in camera or external camera interfacing with second mobile device and converts the camera data into a digital signal in a 2D matrix area of n times 2D images forming the 3D data and with a colour per dot forming the 4D data and transmits that first data through the second data communication channel to the server computer program and server transitory storage medium, and

wherein in the event the server computer program detects data received from the first or second internet enabled wireless mobile device, the data is stored in the server transitory storage medium indexed such that each data is associated to the originating user account of the first or second internet enabled wireless mobile device user, for further processing.

4. A system including a first internet enabled wireless mobile device with a built-in microphone, speaker and camera and at least a second internet enabled wireless mobile device with a built-in microphone, speaker and camera, and at least one server, wherein; the first internet enabled wireless mobile device, a first non-transitory storage medium, and a first computer program product embodied on the first non-transitory storage medium, the first computer program product executable on the first internet enabled wireless mobile device when executed communicates with the server, and the second internet enabled wireless mobile device, a second non-transitory storage medium, and a second computer program product embodied on the second non-transitory storage medium, the second computer program product executable on the second internet enabled wireless mobile device when executed communicates with the server, and

the internet enabled server device, with a third non-transitory storage medium, and a third computer program product embodied on the third non-transitory storage medium, the third computer program product executable on the internet enabled server device when executed communicates with at least the first and/or second internet enabled wireless mobile device, and

wherein when the first computer program product is executable on the first internet enabled wireless mobile device to operate said first data communication with the server, and wherein when the second computer program product is executable on the second internet enabled wireless mobile device said second data communication with the server and,

wherein the first computer program product when executed on the first internet enabled wireless mobile device uses a built-in camera to take one or multiple images from the eyes of the subject in near proximity in front of the built-in camera or external camera interfacing with first mobile device and converts the camera data into a digital representation of (i) the diameter of the iris and/or pupil in horizontal, vertical, and n times diameters at angles between horizontal and vertical and/or (ii) the area of the iris and/or pupil and/or (iii) the colour of the iris and/or pupil and/or the sclera and transmits that first data through the first data communication channel to the server computer program and server transitory storage medium, and

wherein the second computer program product when executed on the second internet enabled wireless mobile device uses a built-in camera to take one or multiple images from the eyes of the subject in near proximity in front of the built-in camera or external camera interfacing with second mobile device and converts the camera data into a digital representation of (i) the diameter of the iris and/or pupil in horizontal, vertical, and n times diameters at angles between horizontal and vertical and/or (ii) the area of the iris and/or pupil and/or (iii) the colour of the iris and/or pupil and/or the sclera and transmits that second data through the second data communication channel to the server computer program and server transitory storage medium, and wherein in the event the server computer program detects data received from the first or second internet enabled wireless mobile device, the data is stored in the server transitory storage medium indexed such that each data is associated to the originating user account of the first or second internet enabled wireless mobile device user, for further processing.

5. The system of any preceding concept 1 to 4, wherein each of the first internet enabled wireless mobile device and the second internet enabled wireless mobile device are a mobile phone, a smartphone, a wireless tablet Computer, a MiFi device, or an Internet of Things (IoT) device.

6. The system of concept 1 or concept 2, wherein the first data and the second data stored in the server transitory storage medium is processed by the server computer program in the following steps;
(i) in the event of a user login of the first internet enabled wireless mobile device and/or the second internet enabled wireless mobile device, comparing the received first data and/or the received second data with all past stored data on the server transitory storage medium of each such first or second user account, and if a data match is found of “n %” or higher then allow such login, and if a data match is found of “m %” or lower, then do not allow such login, and where “m” is equal or less than “n”,
(ii) in the event of a transaction considered critical by a user of the first internet enabled wireless mobile device and/or the second internet enabled wireless mobile device, comparing the received first data and/or the received second data with all past stored data on the server transitory storage medium of each such first or second user account, and if a data match is found of “n %” or higher then allow such transaction considered critical to be executed by the server, and if a data match is found of “m %” or lower then do not allow such transaction considered critical to be executed by the server, and where “m” is less than “n”,
(iii) in the event of a user new account creation of the first internet enabled wireless mobile device and/or the second internet enabled wireless mobile device, comparing the received first data and/or the received second data with all past stored data on the server transitory storage medium of all existing users, blacklisted images and attempted but rejected account creation users, and if a data match is found of “n %” or higher then blacklist and reject a new account opening to that user, and if a data match is found of “m %” or lower, then do allow such new account creation, and where “m” is equal or less than “n”.

7. The system of any preceding concept 1 to 4, wherein the first data and the second data stored in the server transitory storage medium is processed by the server computer program in the following steps;
a.—separate the incoming first data and the second data and the stored data in the server transitory storage medium by “x” groups of colours or colour gradients, thus creating an additional indexing per “colourgroup” per user account wherein two adjacent colourgroups could have the same user in one group (user1.colourgroup1) and in the adjacent group (user1.colourgroup2), and
b.—assign the colour indexing per user account, in example user1 index=colourgroup 1 and colourgroup2 and users 2 index=colourgroupX and coulourgroupX-1, and
c.—in the event of a user login of the first internet enabled wireless mobile device and/or the second internet enabled wireless mobile device, comparing the received first data and/or the received second data with all past stored data on the server transitory storage medium of each such first or second user account BUT only comparing the data of the same colourgroup(s), and if a data match is found of “n %” or higher then allow such login, and if a data match is found of “m %” or lower, then do not allow such login, and where “m” is equal or less than “n”,
d.—in the event of a transaction considered critical by a user of the first internet enabled wireless mobile device and/or the second internet enabled wireless mobile device, comparing the received first data and/or the received second data with all past stored data on the server transitory storage medium of each such first or second user account BUT only comparing the data of the same colourgroup(s), and if a data match is found of “n %” or higher then allow such transaction considered critical to be executed by the server, and if a data match is found of “m %” or lower, then do not allow such transaction considered critical to be executed by the server, and where “m” is equal or less than “n”,
e.—in the event of a user new account creation of the first internet enabled wireless mobile device and/or the second internet enabled wireless mobile device, comparing the received first data and/or the received second data with all past stored data on the server transitory storage medium of all existing users, blacklisted images and attempted but rejected account creation users BUT only comparing the data of the same colourgroup(s), and if a data match is found of “n %” or higher then blacklist and reject a new account opening to that user, and if a data match is found of “m %” or lower, then do allow such new account creation, and where “m” is equal or less than “n”,
f.—and/or wherein
(i) a rectangle “A” is defined of a size of “Z” wide by “X2” high, wherein “Z” is the distance from the centre left pupil to the centre of right pupil and wherein the rectangle “A” is the area that starts from a distance of “X1” above the centre of the left or right pupil upwards, and
(ii) a rectangle “B” is defined of a size of “Z” wide by “Y2” high, wherein “Z” is the distance from the centre left pupil to the centre of right pupil and wherein the rectangle “B” is the area that starts from a distance of “Y1” below the centre of the left or right pupil, and
(iii) wherein the image(s) data of area “A” of a predefined time T1−x (before T1=before eye closing) is compared with the image(s) data of area “A” of a predefined time T2+y (after T2, after eye opening), and
(iv) wherein the image(s) data of area “B” of a predefined time T1−x (before T1) is compared with the image(s) data of area “B” of a predefined time T2+y (after T2), and (vi) wherein in the event the change in percentage of the image(s) of A and/or B before T1 (T1−x) compared to images of A and/or B respectively after T2 (T2+y) as defined previously is higher than g % then the eye blinking is considered as fraudulent and no further interaction is allowed by that user with any user account.

8. The system of any preceding concept 1 to 4, wherein the first data and the second data stored in the server transitory storage medium is processed by the server computer program in the following steps;
a.—separate the incoming first data and the second and the stored data in the server transitory storage medium by two groups of images, a “group_before” of “b” images before the eye starts blinking (closing) and a “group_after” of “a” image(s) after the eye opened per incoming data per user account and
b.—detect and store the time the eyes of the user closed from start of blinking as time T1, until the eyes start to open or end of blinking as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are compared with each other and if a data match is found of “n %” or higher then allow such action (account creation or login or other) to be executed by the server (subject, person or animal is considered alive), and if a data match is found of “m %” or lower, then do not allow such action to be executed by the server (subject, person or animal is considered alive), and
g.—wherein “m” is equal or less than “n”.

9. The system of any preceding concept 1 to 4, wherein the first data and/or the second data stored in server transitory storage medium is processed by the server computer program in the following steps;
a.—separate the incoming first data and the second data and the stored data in the server transitory storage medium by two groups of images, a “group_before” of “b” images before the bright light starts and a “group_after” of “a” image(s) after the dark light starts incoming data per user account and
b.—detect and store the images of the time the first or second computer program product embodied on the first or second non-transitory storage medium of the first or second internet enabled wireless mobile device starts a bright light as time T1, until the bright light ends and dark light starts as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are used to calculate the percentage diameter and/or area change of the iris and/or pupil, and/or
g.—wherein the image(s) of “group_before” and “group_after” are used to calculate the percentage change of colour of the iris and/or pupil and/or sclera, and
h.—if in previous step “f.-” or step “g.-” a percentage change of before vs after is found to be of “n %” or higher is detected then allow such action (account creation or login or other) to be executed by the server (subject, person or animal is considered alive), and if percentage change of before vs after is found to be of “m %” or lower, then do not allow such action to be executed by the server (subject, person or animal is considered alive), and
i.—wherein “m” is less than “n.

10. The system of any preceding concept 1 to 4, wherein the first data and the second data stored in the server transitory storage medium is processed by the server computer program in the following steps;
a.—separate the incoming first data and the second data and the stored data in the server transitory storage medium by two groups of images, a “group_before” of “b” images before the bright light starts and a “group_after” of “a” image(s) after the dark light starts incoming data per user account and
b.—detect and store the images of the time the first or second computer program product embodied on the first or second non-transitory storage medium of the first or second internet enabled wireless mobile device starts showing a small object as time T1, until the time it starts showing that same object very big (close to full screen size) as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are used to calculate the percentage diameter change of the iris and/or pupil, and/or
g.—wherein the image(s) of “group_before” and “group_after” are used to calculate the percentage change of colour of the iris and/or pupil, and
h.—if in previous step “f.-” or step “g.-” a percentage change of before vs after is found to be of “n %” or higher is detected then allow such action (account creation or login or other) to be executed by the server (subject, person or animal is considered alive), and if percentage change of before vs after is found to be of “m %” or lower, then do not allow such action to be executed by the server (subject, person or animal is considered alive), and
i.—wherein “m” is less than “n.

11. A method including a first internet enabled wireless mobile device with a built-in microphone, speaker and camera and at least a second internet enabled wireless mobile device with a built-in microphone, speaker and camera, and at least one server, wherein;

the first internet enabled wireless mobile device, a first non-transitory storage medium, and a first computer program product embodied on the first non-transitory storage medium, the first computer program product executable on the first internet enabled wireless mobile device when executed communicates with the server, and

the second internet enabled wireless mobile device, a second non-transitory storage medium, and a second computer program product embodied on the second non-transitory storage medium, the second computer program product executable on the second internet enabled wireless mobile device when executed communicates with the server, and

the internet enabled server device, with a third non-transitory storage medium, and a third computer program product embodied on the third non-transitory storage medium, the third computer program product executable on the internet enabled server device when executed communicates with at least the first and/or second internet enabled wireless mobile device, and

wherein when the first computer program product is executable on the first internet enabled wireless mobile device to operate said first data communication with the server, and wherein when the second computer program product is executable on the second internet enabled wireless mobile device said second data communication with the server and,

wherein the first computer program product when executed on the first internet enabled wireless mobile device uses the speaker to emit a frequency in the audible and/or inaudible human ear spectrum and the microphones receives the waves bounced back from the face, head or object in near proximity of the first mobile device and converts the analogue signal into a digital signal and transmits that first data through the first data communication channel to the server computer program and server transitory storage medium, and

wherein the second computer program product when executed on the second internet enabled wireless mobile device uses the speaker to emit a frequency in the audible and/or inaudible human ear spectrum and the microphones receives the waves bounced back from the face, head or object in near proximity of the second mobile device and converts the analogue signal into a digital signal and transmits that second data through the second data communication channel to the server computer program and server transitory storage medium, and

wherein in the event the server computer program detects data received from the first or second internet enabled wireless mobile device, the data is stored in the server transitory storage medium indexed such that each data is associated to the originating user account of the first or second internet enabled wireless mobile device user, for further processing.

12. A method including a first internet enabled wireless mobile device with a built-in microphone, speaker and camera and at least a second internet enabled wireless mobile device with a built-in microphone, speaker and camera, and at least one server, wherein; the first internet enabled wireless mobile device, a first non-transitory storage medium, and a first computer program product embodied on the first non-transitory storage medium, the first computer program product executable on the first internet enabled wireless mobile device when executed communicates with the server, and the second internet enabled wireless mobile device, a second non-transitory storage medium, and a second computer program product embodied on the second non-transitory storage medium, the second computer program product executable on the second internet enabled wireless mobile device when executed communicates with the server, and

the internet enabled server device, with a third non-transitory storage medium, and a third computer program product embodied on the third non-transitory storage medium, the third computer program product executable on the internet enabled server device when executed communicates with at least the first and/or second internet enabled wireless mobile device, and

wherein when the first computer program product is executable on the first internet enabled wireless mobile device to operate said first data communication with the server, and wherein when the second computer program product is executable on the second internet enabled wireless mobile device said second data communication with the server and,

wherein the first computer program product when executed on the first internet enabled wireless mobile device uses a frequency transceiver or transducer that emits frequency patterns and receives the frequency waves bounced back from the face, head or object in near proximity of the frequency transceiver or transducer built-in or external interfacing with first mobile device and converts the analogue signal into a digital signal and transmits that first data through the first data communication channel to the server computer program and server transitory storage medium, and

wherein the second computer program product when executed on the second internet enabled wireless mobile device uses a frequency transceiver or transducer that emits frequency patterns and receives the frequency waves bounced back from the face, head or object in near proximity of the frequency transceiver or transducer built-in or external interfacing with first mobile device and converts the analogue signal into a digital signal and transmits that second data through the second data communication channel to the server computer program and server transitory storage medium, and

wherein in the event the server computer program detects data received from the first or second internet enabled wireless mobile device, the data is stored in the server transitory storage medium indexed such that each data is associated to the originating user account of the first or second internet enabled wireless mobile device user, for further processing.

13. A method including a first internet enabled wireless mobile device with a built-in microphone, speaker and camera and at least a second internet enabled wireless mobile device with a built-in microphone, speaker and camera, and at least one server, wherein; the first internet enabled wireless mobile device, a first non-transitory storage medium, and a first computer program product embodied on the first non-transitory storage medium, the first computer program product executable on the first internet enabled wireless mobile device when executed communicates with the server, and

the second internet enabled wireless mobile device, a second non-transitory storage medium, and a second computer program product embodied on the second non-transitory storage medium, the second computer program product executable on the second internet enabled wireless mobile device when executed communicates with the server, and

the internet enabled server device, with a third non-transitory storage medium, and a third computer program product embodied on the third non-transitory storage medium, the third computer program product executable on the internet enabled server device when executed communicates with at least the first and/or second internet enabled wireless mobile device, and

wherein when the first computer program product is executable on the first internet enabled wireless mobile device to operate said first data communication with the server, and wherein when the second computer program product is executable on the second internet enabled wireless mobile device said second data communication with the server and,

wherein the first computer program product when executed on the first internet enabled wireless mobile device uses a built-in camera to take multiple images from the face, head or object in near proximity in front of the built-in camera or external camera interfacing with first mobile device and converts the camera data into a digital signal in a 2D matrix area of n times 2D images forming the 3D data and with a colour per dot forming the 4D data and transmits that first data through the first data communication channel to the server computer program and server transitory storage medium, and wherein the second computer program product when executed on the second internet enabled wireless mobile device uses a built-in camera to take multiple images from the face, head or object in near proximity in front of the built-in camera or external camera interfacing with second mobile device and converts the camera data into a digital signal in a 2D matrix area of n times 2D images forming the 3D data and with a colour per dot forming the 4D data and transmits that second data through the second data communication channel to the server computer program and server transitory storage medium, and

wherein in the event the server computer program detects data received from the first or second internet enabled wireless mobile device, the data is stored in the server transitory storage medium indexed such that each data is associated to the originating user account of the first or second internet enabled wireless mobile device user, for further processing.

14. A method including a first internet enabled wireless mobile device with a built-in microphone, speaker and camera and at least a second internet enabled wireless mobile device with a built-in microphone, speaker and camera, and at least one server, wherein;

the first internet enabled wireless mobile device, a first non-transitory storage medium, and a first computer program product embodied on the first non-transitory storage medium, the first computer program product executable on the first internet enabled wireless mobile device when executed communicates with the server, and

the second internet enabled wireless mobile device, a second non-transitory storage medium, and a second computer program product embodied on the second non-transitory storage medium, the second computer program product executable on the second internet enabled wireless mobile device when executed communicates with the server, and

the internet enabled server device, with a third non-transitory storage medium, and a third computer program product embodied on the third non-transitory storage medium, the third computer program product executable on the internet enabled server device when executed communicates with at least the first and/or second internet enabled wireless mobile device, and

wherein when the first computer program product is executable on the first internet enabled wireless mobile device to operate said first data communication with the server, and wherein when the second computer program product is executable on the second internet enabled wireless mobile device said second data communication with the server and,

wherein the first computer program product when executed on the first internet enabled wireless mobile device uses a built-in camera to take one or multiple images from the eyes of the subject in near proximity in front of the built-in camera or external camera interfacing with first mobile device and converts the camera data into a digital representation of (i) the diameter of the iris and/or pupil in horizontal, vertical, and n times diameters at angles between horizontal and vertical and/or (ii) the area of the iris and/or pupil and/or (iii) the colour of the iris and/or pupil and/or the sclera and transmits that first data through the first data communication channel to the server computer program and server transitory storage medium, and

wherein the second computer program product when executed on the second internet enabled wireless mobile device uses a built-in camera to take one or multiple images from the eyes of the subject in near proximity in front of the built-in camera or external camera interfacing with second mobile device and converts the camera data into a digital representation of (i) the diameter of the iris and/or pupil in horizontal, vertical, and n times diameters at angles between horizontal and vertical and/or (ii) the area of the iris and/or pupil and/or (iii) the colour of the iris and/or pupil and/or the sclera and transmits that second data through the second data communication channel to the server computer program and server transitory storage medium, and

wherein in the event the server computer program detects data received from the first or second internet enabled wireless mobile device, the data is stored in the server transitory storage medium indexed such that each data is associated to the originating user account of the first or second internet enabled wireless mobile device user, for further processing.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

Many modifications and variations or different examples of this present invention are possible in view of the disclosures herein this invention text, figures, drawings, flow-charts and explanations. It is to be understood that, within the scope of the appended claims, the invention can be practiced other than as specifically described in the claims of this invention and new claims can be extracted as new claims or as a divisional patent. The invention which is intended to be protected should not, however, be construed as limited to the particular forms disclosed in the claims, or implementation examples outlined, as these are to be regarded as illustrative rather than restrictive. Variations and changes could be made by those skilled in the art without deviating from the novelty of the invention. Accordingly, the detailed descriptions and figures of this invention should be considered exemplary in nature and not limited to the novelties of the invention as set forth in the claims.

1. A system including a first internet enabled wireless mobile device with a built-in microphone, speaker and camera and at least a second internet enabled wireless mobile device with a built-in microphone, speaker and camera, and at least one internet enabled server device, wherein;
the first internet enabled wireless mobile device includes a first non-transitory storage medium, and a first computer program product embodied on the first non-transitory storage medium, the first computer program product executable on the first internet enabled wireless mobile device, such that the first internet enabled wireless mobile device communicates with the server, and
the second internet enabled wireless mobile device includes a second non-transitory storage medium, and a second computer program product embodied on the second non-transitory storage medium, the second computer program product executable on the second internet enabled wireless mobile device, such that the second internet enabled wireless mobile device communicates with the server, and
the internet enabled server device, including a third non-transitory storage medium, and a third computer program product embodied on the third non-transitory storage medium, wherein the third computer program product is executable on the internet enabled server device, such that the internet enabled server device communicates with at least the first internet enabled wireless mobile device and/or the second internet enabled wireless mobile device, and
wherein the first computer program product is executable on the first internet enabled wireless mobile device to operate a first data communication with the server, and wherein the second computer program product is executable on the second internet enabled wireless mobile device to operate a second data communication with the server and,
wherein the first computer program product is executable on the first internet enabled wireless mobile device to use the speaker to emit a frequency in the audible and/or inaudible human ear spectrum and to receive using the microphone the audio waves bounced back from the face, head or object in near proximity of the first mobile device and to convert the received analogue signal into a first digital signal and to transmit the first digital signal as the first data through the first data communication channel to the internet enabled server device, the internet enabled server device configured to execute the third computer program product to store the first data on a server non-transitory storage medium, and
wherein the second computer program product is executable on the second internet enabled wireless mobile device to use the speaker to emit a frequency in the audible and/or inaudible human ear spectrum and to receive using the microphone the audio waves bounced back from the face, head or object in near proximity of the second mobile device and to convert the received analogue signal into a second digital signal and to transmit the second digital signal as the second data through the second data communication channel to the internet enabled server device, the internet enabled server device executing the third computer program product to store the second data on the server non-transitory storage medium, and
wherein in the event the third computer program product executing on the internet enabled server device detects data received from the first internet enabled wireless mobile device or from the second internet enabled wireless mobile device, the data received is stored in the server non-transitory storage medium and is indexed such that each data is associated to a respective originating user account of the first internet enabled wireless mobile device user or the second internet enabled wireless mobile device user, for further processing.

2. A system including a first internet enabled wireless mobile device with a built-in microphone, speaker and camera and at least a second internet enabled wireless mobile device with a built-in microphone, speaker and camera, and at least one internet enabled server device, wherein;
the first internet enabled wireless mobile device includes a first non-transitory storage medium, and a first computer program product embodied on the first non-transitory storage medium, the first computer program product executable on the first internet enabled wireless mobile device, such that the first internet enabled wireless mobile device communicates with the server, and
the second internet enabled wireless mobile device includes a second non-transitory storage medium, and a second computer program product embodied on the second non-transitory storage medium, the second computer program product executable on the second internet enabled wireless mobile device, such that the second internet enabled wireless mobile device communicates with the server;
the internet enabled server device including a third non-transitory storage medium, and a third computer program product embodied on the third non-transitory storage medium, wherein the third computer program product is executable on the internet enabled server device, such that the internet enabled server device communicates with at least the first internet enabled wireless mobile device and/or the second internet enabled wireless mobile device, and
wherein the first computer program product is executable on the first internet enabled wireless mobile device to operate a first data communication with the server, and wherein the second computer program product is executable on the second internet enabled wireless mobile device to operate a second data communication with the server and,
wherein the first computer program product is executable on the first internet enabled wireless mobile device to use a frequency transceiver or transducer that emits frequency patterns and to receive the frequency waves bounced back from the face, head or object in near proximity of the frequency transceiver or transducer built-in or externally interfacing with the first mobile device and to convert the analogue signal into a first digital signal and to transmit the first digital signal as first data through the first data communication channel to the internet enabled server device, the internet enabled server device executing the third computer program product to store the first data on a server non-transitory storage medium, and
wherein the second computer program product is executable on the second internet enabled wireless mobile device to use a frequency transceiver or transducer that emits frequency patterns and to receive the frequency waves bounced back from the face, head or object in near proximity of the frequency transceiver or transducer built-in or externally interfacing with the second mobile device and to convert the analogue signal into a second digital signal and to transmit the second digital signal as second data through the second data communication channel to the internet enabled server device, the internet enabled server device executing the third computer program product to store the second data on the server non-transitory storage medium, and
wherein in the event the third computer program product executing on the internet enabled server device detects data received from the first internet enabled wireless mobile device or from the second internet enabled wireless mobile device, the data received is stored in the server non-transitory storage medium and is indexed such that each data is associated to a respective originating user account of the first internet enabled wireless mobile device user or the second internet enabled wireless mobile device user, for further processing.

3-4. (canceled)

5. The system of claim 1, wherein each of the first internet enabled wireless mobile device and the second internet enabled wireless mobile device are a mobile phone, a smartphone, a wireless tablet Computer, a MiFi device, or an Internet of Things (IoT) device.

6. The system of claim 1, wherein the first data and the second data stored in the server non-transitory storage medium is processed by the server computer program in the following steps;
(i) in the event of a user login to the server of the first internet enabled wireless mobile device and/or the second internet enabled wireless mobile device, comparing the received first data and/or the received second data with all past stored data on the server non-transitory storage medium of the respective first or second user account, and if a data match is found of “n %” or higher then allow such login, and if a data match is found of “m %” or lower, then do not allow such login, and where “m” is equal or less than “n”,
(ii) in the event of a transaction considered critical by a user of the first internet enabled wireless mobile device and/or the second internet enabled wireless mobile device, comparing the received first data and/or the received second data with all past stored data on the server non-transitory storage medium of the respective first or second user account, and if a data match is found of “n %” or higher then allow such transaction considered critical to be executed by the server, and if a data match is found of “m %” or lower then do not allow such transaction considered critical to be executed by the server, and where “m” is less than “n”,
(iii) in the event of a user new account creation of the first internet enabled wireless mobile device and/or the second internet enabled wireless mobile device, comparing the received first data and/or the received second data with all past stored data on the server non-transitory storage medium of all existing users, blacklisted images and attempted but rejected account creation users, and if a data match is found of “n %” or higher then blacklist and reject a new account opening to that user, and if a data match is found of “m %” or lower, then do allow such new account creation, and where “m” is equal or less than “n”.

7. The system of claim 1, wherein the first data and the second data stored in the server non-transitory storage medium is processed by the server computer program in the following steps;
a.—separate the incoming first data and the incoming second data and the stored data in the server non-transitory storage medium by “x” groups of colours or colour gradients, thus creating an additional indexing per “colourgroup” per user account wherein two adjacent colourgroups could have the same user in one group (user1.colourgroup1) and in the adjacent group (user1.colourgroup2), and
b.—assign the colour indexing per user account, in example user1 index=colourgroup1 and colourgroup2 and users 2 index=colourgroupX and coulourgroupX-1, and
c.—in the event of a user login of the first internet enabled wireless mobile device and/or the second internet enabled wireless mobile device, comparing the received first data and/or the received second data with all past stored data on the server non-transitory storage medium of each such first or second user account BUT only comparing the data of the same colourgroup(s), and if a data match is found of “n %” or higher then allow such login, and if a data match is found of “m %” or lower, then do not allow such login, and where “m” is equal or less than “n”,
d.—in the event of a transaction considered critical by a user of the first internet enabled wireless mobile device and/or the second internet enabled wireless mobile device, comparing the received first data and/or the received second data with all past stored data on the server non-transitory storage medium of each such first or second user account BUT only comparing the data of the same colourgroup(s), and if a data match is found of “n %” or higher then allow such transaction considered critical to be executed by the server, and if a data match is found of “m %” or lower, then do not allow such transaction considered critical to be executed by the server, and where “m” is equal or less than “n”,
e.—in the event of a user new account creation of the first internet enabled wireless mobile device and/or the second internet enabled wireless mobile device, comparing the received first data and/or the received second data with all past stored data on the server non-transitory storage medium of all existing users, blacklisted images and attempted but rejected account creation users BUT only comparing the data of the same colourgroup(s), and if a data match is found of “n %” or higher then blacklist and reject a new account opening to that user, and if a data match is found of “m %” or lower, then do allow such new account creation, and where “m” is equal or less than “n”,
f.—and/or wherein
(i) a rectangle “A” is defined of a size of “Z” wide by “X2” high, wherein “Z” is the distance from the centre of left pupil to the centre of right pupil and wherein the rectangle “A” is the area that starts from a distance of “X1” above the centre of the left or right pupil upwards, and
(ii) a rectangle “B” is defined of a size of “Z” wide by “Y2” high, wherein “Z” is the distance from the centre of left pupil to the centre of right pupil and wherein the rectangle “B” is the area that starts from a distance of “Y1” below the centre of the left or right pupil, and
(iii) wherein the image(s) data of area “A” of a predefined time T1−x (before T1=before eye closing) is compared with the image(s) data of area “A” of a predefined time T2+y (after T2, after eye opening), and
(iv) wherein the image(s) data of area “B” of a predefined time T1−x (before T1) is compared with the image(s) data of area “B” of a predefined time T2+y (after T2), and
(vi) wherein in the event the change in percentage of the image(s) of A and/or B before T1 (T1−x) compared to images of A and/or B respectively after T2 (T2+y) as defined previously is higher than g % then the eye blinking is considered as fraudulent and no further interaction is allowed by that user with any user account.

8. The system of claim 1, wherein the first data and the second data stored in the server non-transitory storage medium is processed by the server computer program in the following steps;
a.—separate the incoming first data and the second data and the stored data in the server non-transitory storage medium by two groups of images, a “group_before” of “b” images before the eye starts blinking (closing) and a “group_after” of “a” image(s) after the eye opened per incoming data per user account and
b.—detect and store the time the eyes of the user closed from start of blinking as time T1, until the eyes start to open or end of blinking as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are compared with each other and if a data match is found of “n %” or higher then allow such action (account creation or login or other) to be executed by the server (subject, person or animal is considered alive), and if a data match is found of “m %” or lower, then do not allow such action to be executed by the server (subject, person or animal is considered alive), and
g.—wherein “m” is equal or less than “n”.

9. The system of claim 1, wherein the first data and/or the second data stored in the server non-transitory storage medium is processed by the server computer program in the following steps;
a.—separate the incoming first data and the second data and the stored data in the server non-transitory storage medium by two groups of images, a “group_before” of “b” images before the bright light starts and a “group_after” of “a” image(s) after the dark light starts, incoming data per user account and
b.—detect and store the images of the time the first or second computer program product embodied on the first or second non-transitory storage medium of the first or second internet enabled wireless mobile device, respectively, starts a bright light as time T1, until the bright light ends and dark light starts as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are used to calculate the percentage diameter and/or area change of the iris and/or pupil, and/or
g.—wherein the image(s) of “group_before” and “group_after” are used to calculate the percentage change of colour of the iris and/or pupil and/or sclera, and
h.—if in previous step “f.-” or step “g.-” a percentage change of before vs after is found to be of “n %” or higher is detected then allow such action (account creation or login or other) to be executed by the server (subject, person or animal is considered alive), and if percentage change of before vs after is found to be of “m %” or lower, then do not allow such action to be executed by the server (subject, person or animal is considered alive), and
i.—wherein “m” is less than “n.

10. The system of claim 1, wherein the first data and the second data stored in the server non-transitory storage medium is processed by the server computer program in the following steps;
a.—separate the incoming first data and the second data and the stored data in the server non-transitory storage medium by two groups of images, a “group_before” of “b” images before the bright light starts and a “group_after” of “a” image(s) after the dark light starts incoming data per user account and
b.—detect and store the images of the time the first or second computer program product embodied on the first or second non-transitory storage medium of the first or second internet enabled wireless mobile device, respectively, starts showing a small object as time T1, until the time it starts showing that same object very big (close to full screen size) as time T2, wherein between T1 and T2 there are no measurements during this timeframe other than establishing T1 and T2, and
c.—the system sets a parameter “x” in milli-seconds to establish the time “T1−x” and uses that as the time period of input data to consider in “group_before” and d.—the system sets a parameter “y” in milli-seconds to establish the time “T2+y” and uses that as the time period of input data to consider in “group_after”, and
e.—wherein x<y, and
f.—wherein the image(s) of “group_before” and “group_after” are used to calculate the percentage diameter change of the iris and/or pupil, and/or
g.—wherein the image(s) of “group_before” and “group_after” are used to calculate the percentage change of colour of the iris and/or pupil, and
h.—if in previous step “f.-” or step “g.-” a percentage change of before vs after is found to be of “′n %” or higher is detected then allow such action (account creation or login or other) to be executed by the server (subject, person or animal is considered alive), and if percentage change of before vs after is found to be of “m %” or lower, then do not allow such action to be executed by the server (subject, person or animal is considered alive), and
i.—wherein “m” is less than “n.

11. A computer-implemented method including using a first internet enabled wireless mobile device with a built-in microphone, speaker and camera and at least a second internet enabled wireless mobile device with a built-in microphone, speaker and camera, and at least one internet enabled server device, wherein:
the first internet enabled wireless mobile device includes a first non-transitory storage medium, and a first computer program product embodied on the first non-transitory storage medium, the first computer program product executable on the first internet enabled wireless mobile device such that the first internet enabled wireless mobile device communicates with the server, and
the second internet enabled wireless mobile device includes a second non-transitory storage medium, and a second computer program product embodied on the second non-transitory storage medium, the second computer program product executable on the second internet enabled wireless mobile device such that the second internet enabled wireless mobile device communicates with the server, and
the internet enabled server device, including a third non-transitory storage medium, and a third computer program product embodied on the third non-transitory storage medium, the third computer program product executable on the internet enabled server device such that the internet enabled server device communicates with at least the first internet enabled wireless mobile device and/or the second internet enabled wireless mobile device, and
wherein the first computer program product executes on the first internet enabled wireless mobile device to operate said first data communication with the server, and wherein the second computer program product executes on the second internet enabled wireless mobile device to operate said second data communication with the server and,
wherein the first computer program product when executing on the first internet enabled wireless mobile device uses the speaker to emit a frequency in the audible and/or inaudible human ear spectrum and the microphone receives the audio waves bounced back from the face, head or object in near proximity of the first mobile device and converts the analogue signal into a digital signal and transmits the digital signal as first data through the first data communication channel, the internet enabled server device executing the third computer program product to store the first data on a server non-transitory storage medium, and
wherein the second computer program product when executing on the second internet enabled wireless mobile device uses the speaker to emit a frequency in the audible and/or inaudible human ear spectrum and the microphone receives the audio waves bounced back from the face, head or object in near proximity of the second mobile device and converts the analogue signal into a digital signal and transmits the digital signal as second data through the second data communication channel, the internet enabled server device executing the third computer program product to store the second data on the server non-transitory storage medium, and
wherein in the event the server computer program executing on the internet enabled server device detects data received from the first internet enabled wireless mobile device or from the second internet enabled wireless mobile device, the data is stored in the server non-transitory storage medium and is indexed such that each data is associated to the corresponding originating user account of the first internet enabled wireless mobile device user or second internet enabled wireless mobile device user, for further processing.

12. A computer-implemented method including using a first internet enabled wireless mobile device with a built-in microphone, speaker and camera and at least a second internet enabled wireless mobile device with a built-in microphone, speaker and camera, and at least one internet enabled server device, wherein:
the first internet enabled wireless mobile device includes a first non-transitory storage medium, and a first computer program product embodied on the first non-transitory storage medium, the first computer program product executable on the first internet enabled wireless mobile device such that the first internet enabled wireless mobile device communicates with the server, and
the second internet enabled wireless mobile device including a second non-transitory storage medium, and a second computer program product embodied on the second non-transitory storage medium, the second computer program product executable on the second internet enabled wireless mobile device such that the second internet enabled wireless mobile device communicates with the server, and
the internet enabled server device, including a third non-transitory storage medium, and a third computer program product embodied on the third non-transitory storage medium, the third computer program product executable on the internet enabled server device such that the internet enabled server device communicates with at least the first internet enabled wireless mobile device and/or the second internet enabled wireless mobile device, and
wherein the first computer program product is executable on the first internet enabled wireless mobile device to operate said first data communication with the server, and wherein when the second computer program product is executable on the second internet enabled wireless mobile device to operate said second data communication with the server and,
wherein the first computer program product when executed on the first internet enabled wireless mobile device uses a frequency transceiver or transducer built-in or externally interfacing with the first mobile device to emit frequency patterns and to receive the frequency waves bounced back from the face, head or object in near proximity of the frequency transceiver or transducer built-in or externally interfacing with the first mobile device and to convert the analogue signal into a digital signal and to transmit the digital signal as first data through the first data communication channel to the internet enabled server device executing the third computer program product to store the first data on a server non-transitory storage medium, and
wherein the second computer program product when executed on the second internet enabled wireless mobile device uses a frequency transceiver or transducer built-in or externally interfacing with the second mobile device to emit frequency patterns and to receive the frequency waves bounced back from the face, head or object in near proximity of the frequency transceiver or transducer built-in or external interfacing with the second mobile device and to convert the analogue signal into a digital signal and to transmit the digital signal as second data through the second data communication channel to the internet enabled server device executing the third computer program product to store the second data on the server non-transitory storage medium, and
wherein in the event the server computer program executing on the internet enabled server device detects data received from the first internet enabled wireless mobile device or second internet enabled wireless mobile device, the data is stored in the server non-transitory storage medium and is indexed such that each data is associated to the corresponding originating user account of the first internet enabled wireless mobile device user or second internet enabled wireless mobile device user, for further processing.

13-15. (canceled)

16. The system of claim 2, wherein each of the first internet enabled wireless mobile device and the second internet enabled wireless mobile device are a mobile phone, a smartphone, a wireless tablet Computer, a MiFi device, or an Internet of Things (IoT) device.

17. The system of claim 2, wherein the first data and the second data stored in the server non-transitory storage medium is processed by the server computer program in the following steps;
(i) in the event of a user login to the server of the first internet enabled wireless mobile device and/or the second internet enabled wireless mobile device, comparing the received first data and/or the received second data with all past stored data on the server non-transitory storage medium of the respective first or second user account, and if a data match is found of “n %” or higher then allow such login, and if a data match is found of “m %” or lower, then do not allow such login, and where “m” is equal or less than “n”,
(ii) in the event of a transaction considered critical by a user of the first internet enabled wireless mobile device and/or the second internet enabled wireless mobile device, comparing the received first data and/or the received second data with all past stored data on the server non-transitory storage medium of the respective first or second user account, and if a data match is found of “n %” or higher then allow such transaction considered critical to be executed by the server, and if a data match is found of “m %” or lower then do not allow such transaction considered critical to be executed by the server, and where “m” is less than “n”,
(iii) in the event of a user new account creation of the first internet enabled wireless mobile device and/or the second internet enabled wireless mobile device, comparing the received first data and/or the received second data with all past stored data on the server non-transitory storage medium of all existing users, blacklisted images and attempted but rejected account creation users, and if a data match is found of “′n %” or higher then blacklist and reject a new account opening to that user, and if a data match is found of “m %” or lower, then do allow such new account creation, and where “m” is equal or less than “n”.

18. The system of claim 2, wherein the first data and the second data stored in the server non-transitory storage medium is processed by the server computer program in the following steps;
a.—separate the incoming first data and the incoming second data and the stored data in the server non-transitory storage medium by “x” groups of colours or colour gradients, thus creating an additional indexing per “colourgroup” per user account wherein two adjacent colourgroups could have the same user in one group (user1.colourgroup1) and in the adjacent group (user1.colourgroup2), and
b.—assign the colour indexing per user account, in example user1 index=colourgroup1 and colourgroup2 and users 2 index=colourgroupX and coulourgroupX-1, and
c.—in the event of a user login of the first internet enabled wireless mobile device and/or the second internet enabled wireless mobile device, comparing the received first data and/or the received second data with all past stored data on the server non-transitory storage medium of each such first or second user account BUT only comparing the data of the same colourgroup(s), and if a data match is found of “n %” or higher then allow such login, and if a data match is found of “m %” or lower, then do not allow such login, and where “m” is equal or less than “n”,
d.—in the event of a transaction considered critical by a user of the first internet enabled wireless mobile device and/or the second internet enabled wireless mobile device, comparing the received first data and/or the received second data with all past stored data on the server non-transitory storage medium of each such first or second user account BUT only comparing the data of the same colourgroup(s), and if a data match is found of “n %” or higher then allow such transaction considered critical to be executed by the server, and if a data match is found of “m %” or lower, then do not allow such transaction considered critical to be executed by the server, and where “m” is equal or less than “n”,
e.—in the event of a user new account creation of the first internet enabled wireless mobile device and/or the second internet enabled wireless mobile device, comparing the received first data and/or the received second data with all past stored data on the server non-transitory storage medium of all existing users, blacklisted images and attempted but rejected account creation users BUT only comparing the data of the same colourgroup(s), and if a data match is found of “n %” or higher then blacklist and reject a new account opening to that user, and if a data match is found of “m %” or lower, then do allow such new account creation, and where “m” is equal or less than “n”,
f.—and/or wherein
(i) a rectangle “A” is defined of a size of “Z” wide by “X2” high, wherein “Z” is the distance from the centre of left pupil to the centre of right pupil and wherein the rectangle “A” is the area that starts from a distance of “X1” above the centre of the left or right pupil upwards, and
(ii) a rectangle “B” is defined of a size of “Z” wide by “Y2” high, wherein “Z” is the distance from the centre of left pupil to the centre of right pupil and wherein the rectangle “B” is the area that starts from a distance of “Y1” below the centre of the left or right pupil, and
(iii) wherein the image(s) data of area “A” of a predefined time T1−x (before T1=before eye closing) is compared with the image(s) data of area “A” of a predefined time T2+y (after T2, after eye opening), and
(iv) wherein the image(s) data of area “B” of a predefined time T1−x (before T1) is compared with the image(s) data of area “B” of a predefined time T2+y (after T2), and
(vi) wherein in the event the change in percentage of the image(s) of A and/or B before T1 (T1−x) compared to images of A and/or B respectively after T2 (T2+y) as defined previously is higher than g % then the eye blinking is considered as fraudulent and no further interaction is allowed by that user with any user account.

19. The system of claim 2, wherein the first data and the second data stored in the server non-transitory storage medium is processed by the server computer program in the following steps;
a.—separate the incoming first data and the second data and the stored data in the server non-transitory storage medium by two groups of images, a “group_before” of “b” images before the eye starts blinking (closing) and a “group_after” of “a” image(s) after the eye opened per incoming data per user account and
b.—detect and store the time the eyes of the user closed from start of blinking as time T1, until the eyes start to open or end of blinking as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are compared with each other and if a data match is found of “n %” or higher then allow such action (account creation or login or other) to be executed by the server (subject, person or animal is considered alive), and if a data match is found of “m %” or lower, then do not allow such action to be executed by the server (subject, person or animal is considered alive), and
g.—wherein “m” is equal or less than “n”.

20. The system of claim 2, wherein the first data and/or the second data stored in the server non-transitory storage medium is processed by the server computer program in the following steps;
a.—separate the incoming first data and the second data and the stored data in the server non-transitory storage medium by two groups of images, a “group_before” of “b” images before the bright light starts and a “group_after” of “a” image(s) after the dark light starts, incoming data per user account and
b.—detect and store the images of the time the first or second computer program product embodied on the first or second non-transitory storage medium of the first or second internet enabled wireless mobile device, respectively, starts a bright light as time T1, until the bright light ends and dark light starts as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are used to calculate the percentage diameter and/or area change of the iris and/or pupil, and/or
g.—wherein the image(s) of “group_before” and “group_after” are used to calculate the percentage change of colour of the iris and/or pupil and/or sclera, and
h.—if in previous step “f.-” or step “g.-” a percentage change of before vs after is found to be of “′n %” or higher is detected then allow such action (account creation or login or other) to be executed by the server (subject, person or animal is considered alive), and if percentage change of before vs after is found to be of “m %” or lower, then do not allow such action to be executed by the server (subject, person or animal is considered alive), and
i.—wherein “m” is less than “n.

21. The system of claim 2, wherein the first data and the second data stored in the server non-transitory storage medium is processed by the server computer program in the following steps;
a.—separate the incoming first data and the second data and the stored data in the server non-transitory storage medium by two groups of images, a “group_before” of “b” images before the bright light starts and a “group_after” of “a” image(s) after the dark light starts incoming data per user account and
b.—detect and store the images of the time the first or second computer program product embodied on the first or second non-transitory storage medium of the first or second internet enabled wireless mobile device, respectively, starts showing a small object as time T1, until the time it starts showing that same object very big (close to full screen size) as time T2, wherein between T1 and T2 there are no measurements during this timeframe other than establishing T1 and T2, and
c.—the system sets a parameter “x” in milli-seconds to establish the time “T1−x” and uses that as the time period of input data to consider in “group_before” and
d.—the system sets a parameter “y” in milli-seconds to establish the time “T2+y” and uses that as the time period of input data to consider in “group_after”, and
e.—wherein x<y, and
f.—wherein the image(s) of “group_before” and “group_after” are used to calculate the percentage diameter change of the iris and/or pupil, and/or
g.—wherein the image(s) of “group_before” and “group_after” are used to calculate the percentage change of colour of the iris and/or pupil, and
h.—if in previous step “f.-” or step “g.-” a percentage change of before vs after is found to be of “′n %” or higher is detected then allow such action (account creation or login or other) to be executed by the server (subject, person or animal is considered alive), and if percentage change of before vs after is found to be of “m %” or lower, then do not allow such action to be executed by the server (subject, person or animal is considered alive), and
i.—wherein “m” is less than “n.

22. The method of claim 11, wherein the first data and the second data stored in the server non-transitory storage medium is processed by the server computer program in the following steps;
(i) in the event of a user login to the server of the first internet enabled wireless mobile device and/or the second internet enabled wireless mobile device, comparing the received first data and/or the received second data with all past stored data on the server non-transitory storage medium of the respective first or second user account, and if a data match is found of “n %” or higher then allow such login, and if a data match is found of “m %” or lower, then do not allow such login, and where “m” is equal or less than “n”,
(ii) in the event of a transaction considered critical by a user of the first internet enabled wireless mobile device and/or the second internet enabled wireless mobile device, comparing the received first data and/or the received second data with all past stored data on the server non-transitory storage medium of the respective first or second user account, and if a data match is found of “n %” or higher then allow such transaction considered critical to be executed by the server, and if a data match is found of “m %” or lower then do not allow such transaction considered critical to be executed by the server, and where “m” is less than “n”,
(iii) in the event of a user new account creation of the first internet enabled wireless mobile device and/or the second internet enabled wireless mobile device, comparing the received first data and/or the received second data with all past stored data on the server non-transitory storage medium of all existing users, blacklisted images and attempted but rejected account creation users, and if a data match is found of “n %” or higher then blacklist and reject a new account opening to that user, and if a data match is found of “m %” or lower, then do allow such new account creation, and where “m” is equal or less than “n”.

23. The method of claim 11, wherein the first data and the second data stored in the server non-transitory storage medium is processed by the server computer program in the following steps;
a.—separate the incoming first data and the incoming second data and the stored data in the server non-transitory storage medium by “x” groups of colours or colour gradients, thus creating an additional indexing per “colourgroup” per user account wherein two adjacent colourgroups could have the same user in one group (user1.colourgroup1) and in the adjacent group (user1.colourgroup2), and
b.—assign the colour indexing per user account, in example user1 index=colourgroup1 and colourgroup2 and users 2 index=colourgroupX and coulourgroupX-1, and
c.—in the event of a user login of the first internet enabled wireless mobile device and/or the second internet enabled wireless mobile device, comparing the received first data and/or the received second data with all past stored data on the server non-transitory storage medium of each such first or second user account BUT only comparing the data of the same colourgroup(s), and if a data match is found of “n %” or higher then allow such login, and if a data match is found of “m %” or lower, then do not allow such login, and where “m” is equal or less than “n”,
d.—in the event of a transaction considered critical by a user of the first internet enabled wireless mobile device and/or the second internet enabled wireless mobile device, comparing the received first data and/or the received second data with all past stored data on the server non-transitory storage medium of each such first or second user account BUT only comparing the data of the same colourgroup(s), and if a data match is found of “n %” or higher then allow such transaction considered critical to be executed by the server, and if a data match is found of “m %” or lower, then do not allow such transaction considered critical to be executed by the server, and where “m” is equal or less than “n”,
e.—in the event of a user new account creation of the first internet enabled wireless mobile device and/or the second internet enabled wireless mobile device, comparing the received first data and/or the received second data with all past stored data on the server non-transitory storage medium of all existing users, blacklisted images and attempted but rejected account creation users BUT only comparing the data of the same colourgroup(s), and if a data match is found of “n %” or higher then blacklist and reject a new account opening to that user, and if a data match is found of “m %” or lower, then do allow such new account creation, and where “m” is equal or less than “n”,
f.—and/or wherein
(i) a rectangle “A” is defined of a size of “Z” wide by “X2” high, wherein “Z” is the distance from the centre of left pupil to the centre of right pupil and wherein the rectangle “A” is the area that starts from a distance of “X1” above the centre of the left or right pupil upwards, and
(ii) a rectangle “B” is defined of a size of “Z” wide by “Y2” high, wherein “Z” is the distance from the centre of left pupil to the centre of right pupil and wherein the rectangle “B” is the area that starts from a distance of “Y1” below the centre of the left or right pupil, and
(iii) wherein the image(s) data of area “A” of a predefined time T1−x (before T1=before eye closing) is compared with the image(s) data of area “A” of a predefined time T2+y (after T2, after eye opening), and
(iv) wherein the image(s) data of area “B” of a predefined time T1−x (before T1) is compared with the image(s) data of area “B” of a predefined time T2+y (after T2), and
(vi) wherein in the event the change in percentage of the image(s) of A and/or B before T1 (T1−x) compared to images of A and/or B respectively after T2 (T2+y) as defined previously is higher than g % then the eye blinking is considered as fraudulent and no further interaction is allowed by that user with any user account.

24. The method of claim 11, wherein the first data and the second data stored in the server non-transitory storage medium is processed by the server computer program in the following steps;
a.—separate the incoming first data and the second data and the stored data in the server non-transitory storage medium by two groups of images, a “group_before” of “b” images before the eye starts blinking (closing) and a “group_after” of “a” image(s) after the eye opened per incoming data per user account and
b.—detect and store the time the eyes of the user closed from start of blinking as time T1, until the eyes start to open or end of blinking as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are compared with each other and if a data match is found of “n %” or higher then allow such action (account creation or login or other) to be executed by the server (subject, person or animal is considered alive), and if a data match is found of “m %” or lower, then do not allow such action to be executed by the server (subject, person or animal is considered alive), and
g.—wherein “m” is equal or less than “n”.

25. The method of claim 11, wherein the first data and/or the second data stored in the server non-transitory storage medium is processed by the server computer program in the following steps;
a.—separate the incoming first data and the second data and the stored data in the server non-transitory storage medium by two groups of images, a “group_before” of “b” images before the bright light starts and a “group_after” of “a” image(s) after the dark light starts, incoming data per user account and
b.—detect and store the images of the time the first or second computer program product embodied on the first or second non-transitory storage medium of the first or second internet enabled wireless mobile device, respectively, starts a bright light as time T1, until the bright light ends and dark light starts as time T2, wherein between T1 and T2 there are no measurements during this timeframe other than establishing T1 and T2, and
c.—the system sets a parameter “x” in milli-seconds to establish the time “T1−x” and use that as the time period of input data to consider in “group_before” and
d.—the system sets a parameter “y” in milli-seconds to establish the time “T2+y” and use that as the time period of input data to consider in “group_after”, and
e.—wherein x<y, and
f.—wherein the image(s) of “group_before” and “group_after” are used to calculate the percentage diameter and/or area change of the iris and/or pupil, and/or
g.—wherein the image(s) of “group_before” and “group_after” are used to calculate the percentage change of colour of the iris and/or pupil and/or sclera, and
h.—if in previous step “f.-” or step “g.-” a percentage change of before vs after is found to be of “′n %” or higher is detected then allow such action (account creation or login or other) to be executed by the server (subject, person or animal is considered alive), and if percentage change of before vs after is found to be of “m %” or lower, then do not allow such action to be executed by the server (subject, person or animal is considered alive), and
i.—wherein “m” is less than “n.
